(19) United States
(12) Patent Application Publication
(10) Pub. No.: US 2018/0004659 A1
(43) Pub. Date: Jan. 4, 2018

(54) CRIBBING CACHE IMPLEMENTING HIGHLY COMPRESSIBLE DATA INDICATION

(71) Applicant: Intel Corporation, Santa Clara, CA (US)

(72) Inventor: Daniel GREENSPAN, Jerusalem (IL)

(21) Appl. No.: 15/201,366

(22) Filed: Jul. 1, 2016

(51) Int. Cl. G06F 12/0802

(52) U.S. Cl. CPC G06F 12/0802; G06F 2212/604

(57) ABSTRACT

A memory subsystem includes a flag to indicate high compressibility, which enables a cache controller to selectively avoid access to the data from a memory resource based on an indication of the flag. The main memory device stores data and the auxiliary memory device stores a copy of the data. The cache controller can determine whether the memory location includes highly compressible data and store a flag locally at the cache controller as a representation for high compressibility. The flag is accessible without external input/output (I/O) from the cache controller, and indicates whether the data includes highly compressible data. The flag can optionally indicate a type of highly compressible data. In response to a memory access request for the memory location, the cache controller can return fulfillment of the memory access request according to the representation of high compressibility indicated by the flag.

### FIELD

The descriptions are generally related to multilevel memory systems, and more particular descriptions are related to accessing cached data based on an indication of whether the data is highly compressible.

### COPYRIGHT NOTICE/PERMISSION

Portions of the disclosure of this patent document may contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright © 2016, Intel Corporation, All Rights Reserved.

### BACKGROUND

Processor performance was once measured almost solely based on clock speed, with the implication that a higher clock speed resulting in better performance. Another perspective on processor performance is how much the processor can do over a given time. Thus, while clock speeds have leveled off, the number of cores and concurrent threading capability has increased, by which processor throughput continues to improve. For a processor to continue to experience increased overall performance, data must get to and from the processing units. Processor speeds are significantly higher than memory speeds, which means data access can bottleneck the operation of the processor.

Computing device often include two-level memory systems or multilevel memory systems, where there are multiple “levels” of memory resources, with at least one that is “closer” to the processor and one that is “farther” from the processor. Closer and farther can be relative terms referring to the delay incurred by accessing the memory resources. Thus, a closer memory resource, which is often referred to as “near memory,” has lower access delay than the farther memory resource, often referred to as “far memory.” Near memory and far memory is similar in concept to caching, with local memory resources that are smaller and faster that store and synchronize data belonging to larger and slower memory devices. Caching often refers to the use of fully on-die memory technologies to provide a cache focused on serving the on-die CPUs (central processing units), whereas with near and far memory, the focus is on serving all users of memory sub-systems, and in some cases the memory technologies chosen for near and far memory may be of similar technology but implementing different trade-offs between cost, proximity to CPU package, and size. For example, a smaller DRAM (dynamic random access memory) device can be incorporated on-package or otherwise closer to a processor, which is of the same or similar technology as main memory DRAM, but will have a lower access delay due to a shorter interconnect distance.

Every access to both near memory and far memory takes time and uses power. Many access transactions (where a transaction refers to the access of one or more bits over one or more transfer cycles) involve transmission of data that has no data value (for example, a record of the last 100 failure events when no failure has occurred) or has known data patterns. Compression solutions exist and work well to reduce the need to transfer zero data or known patterns or both. However, even the best compression requires the system to access the memory for the data and reconstruct the compressed data after access. The request and return is costly in terms of time and performance, especially in a case where there is no data in the requested memory location(s).

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, and/or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of a memory subsystem in which a cache controller for an auxiliary memory utilizes high compressibility flags.

FIG. 2A is a block diagram of an embodiment of a system illustrating the application of a highly compressible data indication.

FIG. 2B is a block diagram of an embodiment of a system illustrating a high compressibility indication.

FIG. 3 is a block diagram of an embodiment of a memory subsystem with an integrated near memory controller and an integrated far memory controller.

FIG. 4A is a flow diagram of an embodiment of a process for accessing data in a multilevel memory.

FIG. 4B is a flow diagram of an embodiment of a process for processing a read access request in a system with a high compressibility flag.

FIG. 4C is a flow diagram of an embodiment of a process for processing a write access request in a system with a high compressibility flag.

FIG. 5 is a block diagram of an embodiment of a computing system with a multilevel memory in which high compressibility flags can be implemented.

FIG. 6 is a block diagram of an embodiment of a mobile device with a multilevel memory in which high compressibility flags can be implemented.

Descriptions of certain details and implementations follow, including a description of the figures, which may depict some or all of the embodiments described below, as well as discussing other potential embodiments or implementations of the inventive concepts presented herein.

### DETAILED DESCRIPTION

As described herein, a stored flag in a multilevel memory indicates whether data is highly compressible. The high compressibility indication can be a simple indication of highly compressible data, or can indicate one of several patterns of the high compressibility in addition to indicating high compressibility. In general compression refers to the representation of data by a reduced number of bits. Highly compressible data is data that can be represented by a relatively low number of bits compared to the original number of bits of data. For example, if all zeros (AZ), all ones, or all fives (binary ‘0101’) are patterns that frequently show up in data (which is generally true), a binary pattern of 2 bits could represent each of the three cases (in addition to the case where no highly compressible data was found), no matter how many bits originally have the pattern, e.g., 8 bits, 32 bits, or 128 bits of the pattern could potentially be represented by the two bits. Other common patterns are possible, including examples such as uniformly incrementing data, one-hot encoding, 8×8 JPEG matrix of a specific color, and the like, as appropriate for the application where the data structure is present. For data that is highly compressible, in one embodiment, a cache controller or controller for near memory can store one or more flags locally to the controller, which can enable the controller to selectively avoid access to the data from a memory resource based on an indication of the flag. The one or more flags can each include one or more bits to provide a high compressibility representation.

In one embodiment, a two-level memory (2LM) or multilevel memory (MLM) system includes a main memory device to store data as the primary operational data for the system, and includes an auxiliary memory device to store a copy of a subset of the data. Such a memory system can be operated in accordance with known techniques for multilevel memory with synchronization between the primary or main memory and the auxiliary memory (such as write-back, write-through, or other techniques). In one embodiment, the primary memory is a far memory and the auxiliary memory is a near memory.

It will be understood that with certain other applications of compression, such as the use of an AZ bit or bit field, a zero indicator bit (ZIB), or other indicator, the system stores only the indicator (for example, the ZIB) and not the data itself in the auxiliary memory. While such an approach can reduce the bandwidth needed to transfer the data, there often needs to be an access made to the memory to access the indicator, and then processing to reconstruct the data. The indicator can be referred to as a flag. As described herein, a controller keeps a high compressibility flag locally, and in certain cases can respond to a request for a memory location without needing to access the memory location at all. The high compressibility flag is an indicator of whether data is highly compressible, and can represent a specific highly compressible bit pattern. In traditional applications of compression, only the ZIB or the compressed data is written. In contrast, as described herein, the original data exists in main memory, and the auxiliary memory includes a copy of that data, but the controller includes a high compressibility flag that indicates what the value of data at certain memory locations is, which prevents the need to access the data in the case of a read access request. Thus the controller's flag may be considered a “crib” or shorthand copy of the data held in the auxiliary memory, as opposed to a substitute for having ensured that the data is stored in the auxiliary memory.

Consider an analogy of a weather forecaster looking for historical weather data stored in paper form in various binders. The binders include the historical weather data, and a catalog maps to the binders. If the catalog includes a sticker or indicator next to certain weeks or days or other time periods to indicate, for example, that there is no data for that specific period, the weather forecaster can see from looking at the catalog that there is no data in the binder. The weather forecaster does not need to go find the binder and look to the specific time period, because the forecaster already knows there will not be any data to find. Similarly, the high compressibility flag can flag the value of data contents at a memory location for a controller, without the need to schedule and execute access to the memory location. In one embodiment, the controller can simply return the results of the access request without having to access the memory location.

Similarly, in one embodiment, the cache controller can determine whether a memory location includes highly compressible data and store a flag locally at the cache controller as a representation for the highly compressed data. The flag is accessible without external input/output (I/O) from the cache controller, and indicates whether the data includes highly compressible data. In one embodiment, the flag can have multiple values when set, each value indicating a type or pattern of highly compressible data. In response to a memory access request for the memory location, the cache controller can return fulfillment of the memory access request according to the representation of high compressibility indicated by the flag, which can include returning fulfillment of the request without access to the memory when the flag indicates highly compressed data.

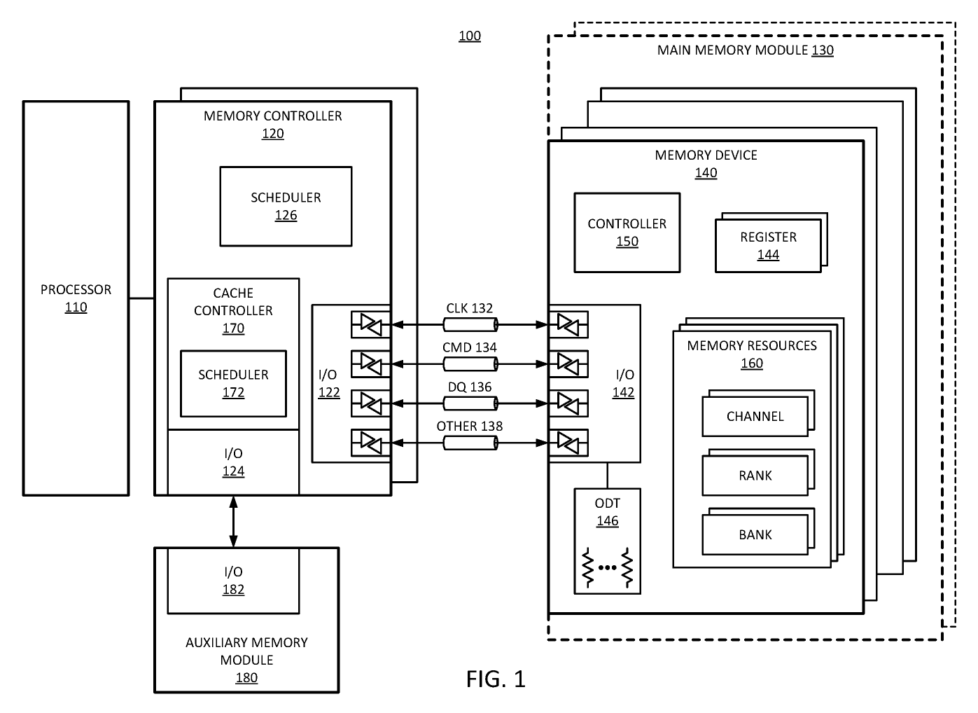

FIG. 1 is a block diagram of an embodiment of a memory subsystem in which an auxiliary memory controller utilizes high compressibility flags. System 100 includes a processor and elements of a memory subsystem in a computing device. Processor 110 represents a processing unit of a computing platform that may execute an operating system (OS) and applications, which can collectively be referred to as the user of the memory. The OS and applications execute operations that result in memory accesses. Processor 110 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory accesses may also be initiated by devices such as a network controller or hard disk controller. Such devices can be integrated with the processor in some systems or attached to the processor via a bus (e.g., PCI express), or a combination. System 100 can be implemented as an SOC (system on a chip), or be implemented with standalone components.

Reference to memory devices can apply to different memory types. Memory devices often refers to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR3 (dual data rate version 3, original release by JEDEC (Joint Electronic Device Engineering Council) on Jun. 27, 2007, currently on release 21), DDR4 (DDR version 4, initial specification published in September 2012 by JEDEC), DDR4E (DDR version 4, extended, currently in discussion by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (currently in discussion by JEDEC), HBM2 (HBM version 2), currently in discussion by JEDEC), or others or combinations of memory technologies, and technologies based on derivatives or extensions of such specifications.

In addition to, or alternatively to, volatile memory, in one embodiment, reference to memory devices can refer to a nonvolatile memory device whose state is determinate even if power is interrupted to the device. In one embodiment, the nonvolatile memory device is a block addressable memory device, such as NAND or NOR technologies. Thus, a memory device can also include a future generation nonvolatile devices, such as a three dimensional crosspoint (3DXP) memory device, other byte addressable nonvolatile memory devices, or memory devices that use chalcogenide phase change material (e.g., chalcogenide glass). In one embodiment, the memory device can be or include multi-threshold level NAND flash memory, NOR flash memory, single or multi-level phase change memory (PCM) or phase change memory with a switch (PCMS), a resistive memory, nanowire memory, ferroelectric transistor random access memory (FeTRAM), magnetoresistive random access memory (MRAM) memory that incorporates memristor technology, or spin transfer torque (STT)-MRAM, or a combination of any of the above, or other memory.

Descriptions herein referring to a “DRAM” or “DRAM device” can apply to any memory device that allows random access, whether volatile or nonvolatile. The memory device or DRAM can refer to the die itself, to a packaged memory product that includes one or more dies, or both.

Memory controller 120 represents one or more memory controller circuits or devices for system 100. Memory controller 120 represents control logic that generates memory access commands in response to the execution of operations by processor 110. Memory controller 120 accesses one or more memory devices 140. Memory devices 140 can be DRAM devices in accordance with any referred to above. In one embodiment, memory devices 140 are organized and managed as different channels, where each channel couples to buses and signal lines that couple to multiple memory devices in parallel. Each channel is independently operable. Thus, each channel is independently accessed and controlled, and the timing, data transfer, command and address exchanges, and other operations are separate for each channel. As used herein, coupling can refer to an electrical coupling, communicative coupling, physical coupling, or a combination of these. Physical coupling can include direct contact. Electrical coupling includes an interface or interconnection that allows electrical flow between components, or allows signaling between components, or both. Communicative coupling includes connections, including wired or wireless, that enable components to exchange data.

In one embodiment, settings for each channel are controlled by separate mode registers or other register settings. In one embodiment, each memory controller 120 manages a separate memory channel, although system 100 can be configured to have multiple channels managed by a single controller, or to have multiple controllers on a single channel. In one embodiment, memory controller 120 is part of host processor 110, such as logic implemented on the same die or implemented in the same package space as the processor.

Memory controller 120 includes I/O interface logic 122 to couple to a memory bus, such as a memory channel as referred to above. I/O interface logic 122 (as well as I/O interface logic 142 of memory device 140) can include pins, pads, connectors, signal lines, traces, or wires, or other hardware to connect the devices, or a combination of these. I/O interface logic 122 can include a hardware interface. As illustrated, I/O interface logic 122 includes at least drivers/transceivers for signal lines. Commonly, wires within an integrated circuit interface couple with a pad, pin, or connector to interface signal lines or traces or other wires between devices. I/O interface logic 122 can include drivers, receivers, transceivers, or termination, or other circuitry or combinations of circuitry to exchange signals on the signal lines between the devices. The exchange of signals includes at least one of transmit or receive. While shown as coupling I/O 122 from memory controller 120 to I/O 142 of memory device 140, it will be understood that in an implementation of system 100 where groups of memory devices 140 are accessed in parallel, multiple memory devices can include I/O interfaces to the same interface of memory controller 120. In an implementation of system 100 including one or more memory modules 130, I/O 142 can include interface hardware of the memory module in addition to interface hardware on the memory device itself. Other memory controllers 120 will include separate interfaces to other memory devices 140.

The bus between memory controller 120 and memory devices 140 can be implemented as multiple signal lines coupling memory controller 120 to memory devices 140. The bus may typically include at least clock (CLK) 132, command/address (CMD) and write data (DQ) 134, read DQ 136, and zero or more other signal lines 138. In one embodiment, a bus or connection between memory controller 120 and memory can be referred to as a memory bus. The signal lines for CMD can be referred to as a “C/A bus” (or ADD/CMD bus, or some other designation indicating the transfer of commands and address information) and the signal lines for write and read DQ can be referred to as a “data bus.” In one embodiment, independent channels have different clock signals, C/A buses, data buses, and other signal lines. Thus, system 100 can be considered to have multiple “buses,” in the sense that an independent interface path can be considered a separate bus. It will be understood that in addition to the lines explicitly shown, a bus can include at least one of strobe signaling lines, alert lines, auxiliary lines, or other signal lines, or a combination. It will also be understood that serial bus technologies can be used for the connection between memory controller 120 and memory devices 140. An example of a serial bus technology is 8B10B encoding and transmission of high-speed data with embedded clock over a single differential pair of signals in each direction.

It will be understood that in the example of system 100, the bus between memory controller 120 and memory devices 140 includes a subsidiary command bus CMD 134 and a subsidiary bus to carry the write and read data, DQ 136. In one embodiment, the data bus can includes bidirectional lines for read data and for write/command data. In another embodiment, the subsidiary bus DQ 136 can include unidirectional write signal lines for write and data from the host to memory, and can include unidirectional lines for read data from the memory to the host. In accordance with the chosen memory technology and system design, a number other signals 138 may accompany the sub buses, such as strobe lines DQS. Based on design of system 100, or implementation if a design supports multiple implementations, the data bus can have more or less bandwidth per memory device 140. For example, the data bus can support memory devices that have either a x32 interface, a x16 interface, a x8 interface, or other interface. The convention “xW,” where W is a binary integer refers to an interface size of memory device 140, which represents a number of signal lines to exchange data with memory controller 120. The interface size of the memory devices is a controlling factor on how many memory devices can be used concurrently per channel in system 100 or coupled in parallel to the same signal lines.

Memory devices 140 represent memory resources for system 100. In one embodiment, each memory device 140 is a separate memory die. In one embodiment, each memory device 140 can interface with multiple (e.g., 2) channels per device or die. Each memory device 140 includes I/O interface logic 142, which has a bandwidth determined by the implementation of the device (e.g., x16 or x8 or some other interface bandwidth). I/O interface logic 142 enables the memory devices to interface with memory controller 120. I/O interface logic 142 can include a hardware interface, and can be in accordance with I/O 122 of memory controller, but at the memory device end. In one embodiment, multiple memory devices 140 are connected in parallel to the same command and data buses. In another embodiment, multiple memory devices 140 are connected in parallel to the same command bus, and are connected to different data buses. For example, system 100 can be configured with multiple memory devices 140 coupled in parallel, with each memory device responding to a command, and accessing memory resources 160 internal to each. For a Write operation, an individual memory device 140 can write a portion of the overall data word, and for a Read operation, an individual memory device 140 can fetch a portion of the overall data word.

In one embodiment, memory devices 140 are disposed directly on a motherboard or host system platform (e.g., a PCB (printed circuit board) on which processor 110 is disposed) of a computing device. In one embodiment, memory devices 140 can be organized into memory modules 130. In one embodiment, memory modules 130 represent dual inline memory modules (DIMMs). In one embodiment, memory modules 130 represent other organization of multiple memory devices to share at least a portion of access or control circuitry, which can be a separate circuit, a separate device, or a separate board from the host system platform. Memory modules 130 can include multiple memory devices 140, and the memory modules can include support for multiple separate channels to the included memory devices disposed on them. In another embodiment, memory devices 140 may be incorporated into the same package as memory controller 120, such as by techniques such as multi-chip-module (MCM), package-on-package, through-silicon VIA (TSV), or other techniques. Similarly, in another embodiment, multiple memory devices 140 may be incorporated into memory modules 130, which themselves may be incorporated into the same package as memory controller 120. It will be appreciated that for these and other embodiments, memory controller 120 may be part of host processor 110.

Memory devices 140 each include memory resources 160. Memory resources 160 represent individual arrays of memory locations or storage locations for data. Typically memory resources 160 are managed as rows of data, accessed via wordline (rows) and bitline (individual bits within a row) control. Memory resources 160 can be organized as separate channels, ranks, and banks of memory. Channels may refer to independent control paths to storage locations within memory devices 140. Ranks may refer to common locations across multiple memory devices (e.g., same row addresses within different devices). Banks may refer to arrays of memory locations within a memory device 140. In one embodiment, banks of memory are divided into sub-banks with at least a portion of shared circuitry (e.g., drivers, signal lines, control logic) for the sub-banks. It will be understood that channels, ranks, banks, or other organizations of the memory locations, and combinations of the organizations, can overlap in their application to physical resources. For example, the same physical memory locations can be accessed over a specific channel as a specific bank, which can also belong to a rank. Thus, the organization of memory resources will be understood in an inclusive, rather than exclusive, manner.

In one embodiment, memory devices 140 include one or more registers 144. Register 144 represents one or more storage devices or storage locations that provide configuration or settings for the operation of the memory device. In one embodiment, register 144 can provide a storage location for memory device 140 to store data for access by memory controller 120 as part of a control or management operation. In one embodiment, register 144 includes one or more Mode Registers. In one embodiment, register 144 includes one or more multipurpose registers. The configuration of locations within register 144 can configure memory device 140 to operate in different “mode,” where command information can trigger different operations within memory device 140 based on the mode. Additionally or in the alternative, different modes can also trigger different operation from address information or other signal lines depending on the mode. Settings of register 144 can indicate configuration for I/O settings (e.g., timing, termination or ODT (on-die termination), driver configuration, or other I/O settings).

In one embodiment, memory device 140 includes ODT 146 as part of the interface hardware associated with I/O 142. ODT 146 can be configured as mentioned above, and provide settings for impedance to be applied to the interface to specified signal lines. The ODT settings can be changed based on whether a memory device is a selected target of an access operation or a non-target device. ODT 146 settings can affect the timing and reflections of signaling on the terminated lines. Careful control over ODT 146 can enable higher-speed operation with improved matching of applied impedance and loading. ODT 146 can be applied to specific signal lines of I/O interface 142, 122, and is not necessarily applied to all signal lines.

Memory device 140 includes controller 150, which represents control logic within the memory device to control internal operations within the memory device. For example, controller 150 decodes commands sent by memory controller 120 and generates internal operations to execute or satisfy the commands. Controller 150 can be referred to as an internal controller, and is separate from memory controller 120 of the host. Controller 150 can determine what mode is selected based on register 144, and configure the internal execution of operations for access to memory resources 160 or other operations based on the selected mode. Controller 150 generates control signals to control the routing of bits within memory device 140 to provide a proper interface for the selected mode and direct a command to the proper memory locations or addresses.

Referring again to memory controller 120, memory controller 120 includes scheduler 126, which represents logic or circuitry to generate and order transactions to send to memory device 140. From one perspective, the primary function of memory controller 120 could be said to schedule memory access and other transactions to memory device 140. Such scheduling can include generating the transactions themselves to implement the requests for data by processor 110 and to maintain integrity of the data (e.g., such as with commands related to refresh). Transactions can include one or more commands, and result in the transfer of commands or data or both over one or multiple clock or timing cycles. Transactions can be for access such as read or write or related commands or a combination, and other transactions can include memory management commands for configuration, settings, data integrity, or other commands or a combination.

Memory controller 120 typically includes logic to allow selection and ordering of transactions to improve performance of system 100. Thus, memory controller 120 can select which of the outstanding transactions should be sent to memory device 140 in which order, which is typically achieved with logic much more complex that a simple first-in first-out algorithm. Memory controller 120 manages the transmission of the transactions to memory device 140, and manages the timing associated with the transaction. Transactions typically have deterministic timing, which can be managed by memory controller 120 and used in determining how to schedule the transactions.

In one embodiment, memory controller 120 includes cache controller 170. In one embodiment, cache controller 170 is separate from memory controller 120. Cache controller 170 can be a subset of scheduler 126, in one embodiment. Cache controller 170 is also illustrated to include scheduler 172, which is similar in form and function with scheduler 126, or which is part of scheduler 126. Scheduler 172 represents the scheduling function for transactions related to access and management of auxiliary memory module 180, while scheduler 126 more specifically represents the scheduling function for memory device 140. In one embodiment, auxiliary memory module 172 represents near memory, and scheduler 172 schedules the transactions for access to near memory, and main memory module 130 represents far memory, and scheduler 126 schedules the transactions for access to far memory.

In response to scheduling of transactions for memory device 140, memory controller 120 can issue commands via I/O 122 to cause memory device 140 to execute the commands. In one embodiment, controller 150 of memory device 140 receives and decodes command and address information received via I/O 142 from memory controller 120. Based on the received command and address information, controller 150 can control the timing of operations of the logic and circuitry within memory device 140 to execute the commands. Controller 150 is responsible for compliance with standards or specifications within memory device 140, such as timing and signaling requirements. Memory controller 120 can implement compliance with standards or specifications by access scheduling and control.

In a similar manner, cache controller 170 can issue access commands via I/O 124 to I/O 182 of auxiliary memory module 180. While the specific internal structure of memory within auxiliary memory module 180 is not illustrated, in one embodiment, it is the same or similar to memory device 140. In one embodiment, auxiliary memory module 180 includes SRAM (synchronous random access memory) instead of or in addition to DRAM. I/O 124 can be the same or similar to I/O 122, with one or more buses provided via signal lines that couple auxiliary memory module 180 to memory controller 120.

System 100 can operate as a 2LM system with auxiliary memory module 180 having a lower access delay than main memory module 130. In one embodiment, both auxiliary memory module 180 and main memory module 130 include DRAM devices. In one embodiment, the lower access delay of auxiliary memory module 180 is achieved as a direct result of physical proximity to memory controller 120 (such as being assembled in the same device package as memory controller 120). Auxiliary memory module 180 could be considered the data storage for the “cache” implemented by cache controller 120, such a cache mechanism having multiple orders of magnitude greater capacity than a cache implemented on the same piece of silicon as memory controller 120. In one embodiment, auxiliary memory module 180 has capacity between the capacity of main memory module 130, and the capacity of what is typically implemented for an on-die cache. As one example, consider a system 100 that implements auxiliary memory module 180 as a large memory-size cache in a DRAM device such as WIO2 memory (such DRAM device may be assembled on top of the piece of silicon holding memory controller 120 by means of through-silicon-via), where cache controller 170 includes on-die metadata storage.

It will be understood that bringing the memory closer to cache controller 170 allows an improved access time. Likewise, using a smaller number of memories for auxiliary memory module 180 than would typically be used for main memory module 130 reducing loading effects on the bus such as sub-bus CMD 134, allowing for further improvement in access time. However, it will also be understood that there is a limited amount of memory that can be brought on-die or on resource to cache controller 170 or memory controller 120. In one embodiment, with on resource metadata, cache controller 170 can store high compressibility flags in accordance with any embodiment described herein. Cache controller 170 can adjust the operation of scheduler 172 (and potentially of scheduler 126) based on high compressibility flag metadata.

As previously described, the use of a high compressibility indication can provide performance improvements for access to data with identifiable patterns, such as could be identified with the high compressibility flag. One specific implementation of interest is for all zeros (AZ) data. Research has indicated that a significant portion (in some cases 10%) of pages in memory contain the data value zero for all bytes in the page. Based on cache data fetch behavior, there is little additional upfront cost to identify that a page contains all zeros. Similar low-cost mechanisms can be provided to identify data of other patterns. Such patterns to be recognized may be configured in advance according to the expected data structures present in the system. Such patterns may be also selected by the cache controller during operation (for example, from a larger subset of pre-configured patterns, in accordance with a run-time observation of which of the subset are appearing most frequently). In some systems, the main memory or the interface to the main memory or both implement an optimization to represent the AZ pages, for example to improve interface bandwidth or to allow reset-counter-based zeroing of data. Other systems are known where the main memory or the interface to it or both implement optimizations for other common data patterns. In one embodiment, cache controller 170 can store one or more additional bits of metadata for cache entries to represent that the data for a specific entry is all zero or a common pattern. In one embodiment where cache controller 170 stores multiple bits, the multiple bits can be used to identify portions of the data that is highly compressible. In one embodiment, cache controller 170 stores the bit or bits together with existing metadata for the cache entries. In one embodiment, cache controller 170 stores the bit or bits as part of a new metadata structure for high compressibility indication. It will be understood that cache controller 170 is configured to access cache metadata, e.g., for tags, before accessing the cache data. Thus, the use of a high compressibility indication flag metadata is expected to introduce little to no latency to the operation of the controller.

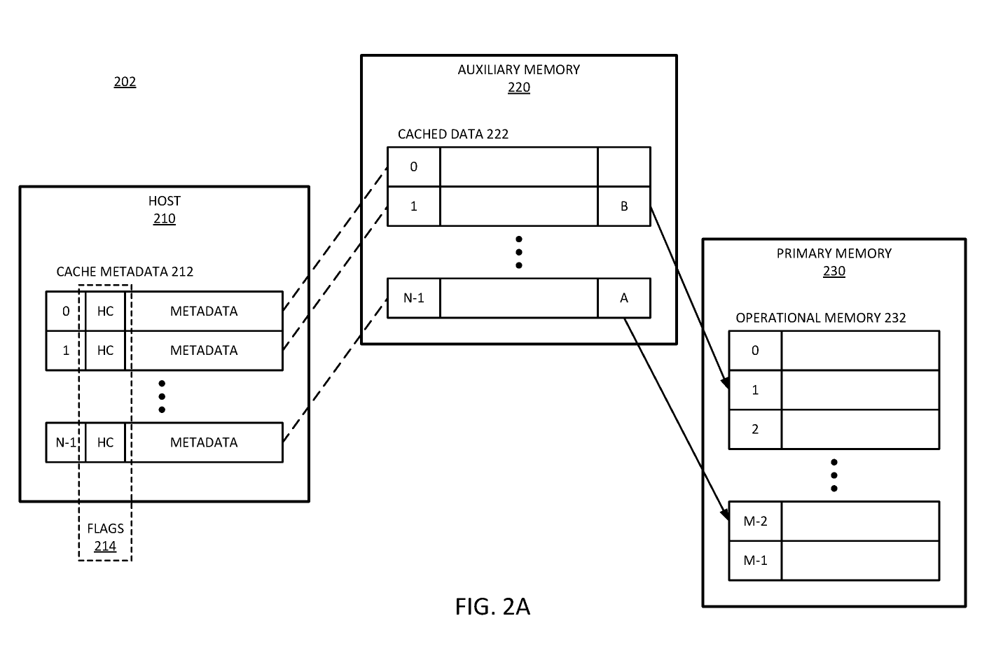

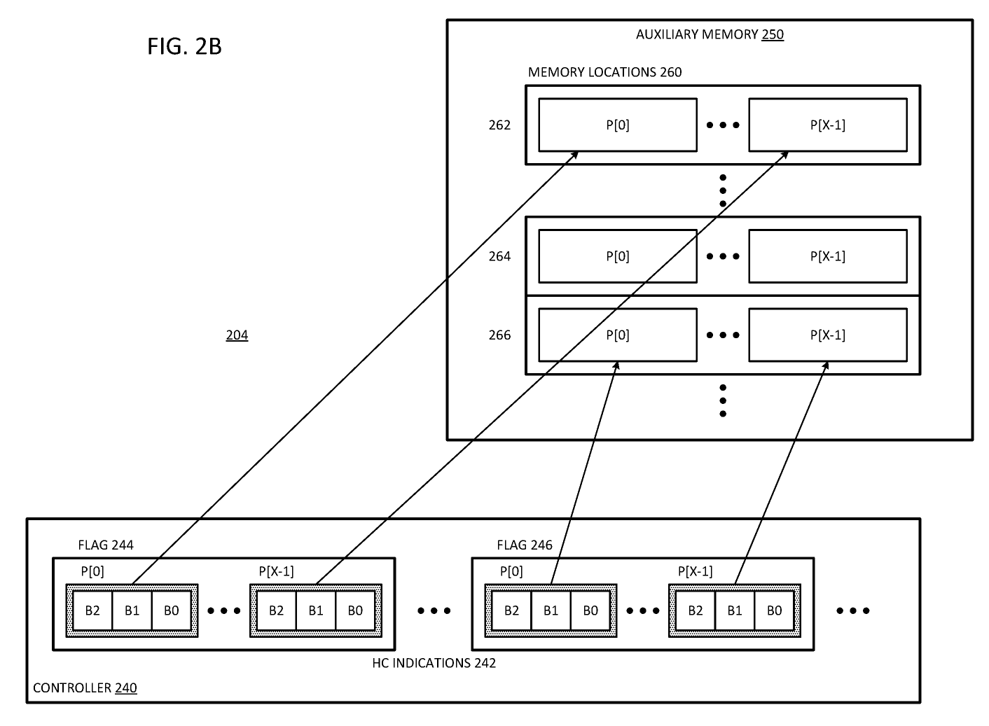

FIG. 2A is a block diagram of an embodiment of a system illustrating the application of a highly compressible data indication. System 202 represents system components of a multilevel memory in accordance with an embodiment of system 100 of FIG. 1. Host 210 represents components of the hardware and software platform for system 202. Host 210 can include one or more processor components as well as memory controller circuitry and cache controller circuits. In one embodiment, the memory controller circuits include one or more cache controllers to manage access to auxiliary memory 220.

As a multilevel memory system, system 202 includes primary memory 230 and auxiliary memory 220. Primary memory 230 represents system main memory, which holds operational data for the operation of one or more processors of host 210. Primary memory 230 holds “loaded” programs and services, such as instructions and data for OS and applications, which can be loaded from storage (not specifically shown). Auxiliary memory 220 represents additional memory that is separate from primary memory 230. In one embodiment, separate memory refers to the fact that host 210 includes a separate controller to manage access to the memory devices. In one embodiment, separate memory refers to the fact that the bus structures to the memory devices are different resulting in differing access latencies, even if the same controller or a different controller are implemented.

System 202 is an MLM system. A multilevel system may also be referred to as a multi-tiered system or a multi-tiered memory. In one embodiment, system 202 is a 2LM system as shown. In one embodiment, system 202 includes one or more levels of memory in addition to what is illustrated. In one embodiment, system 202 utilizes DRAM memory technologies for both primary memory 230 and auxiliary memory 220. Auxiliary memory 220 could be describable storing “cached data,” or holding data for a cache device. In one embodiment, auxiliary memory 220 is part of a “cache,” which can be considered to include a cache controller (not specifically shown in system 202), a store of cache metadata 212 typically stored locally to the cache controller, and the data stored in auxiliary memory 220.

In one embodiment, auxiliary memory 220 operates as a caching device and does not have its own individual addressing space as system-addressable memory. Thus, “memory locations” as requested by host 210 will refer to the address space of primary memory 230, and auxiliary memory 220 entries are mapped to memory locations of primary memory 230, for example with mapping provided by a cache controller according to metadata held by the cache controller. It will be understood that while operational memory 232 is typically organized with contiguous linear memory addresses, cached data 222 is not necessarily organized in address order when considered from a system memory map perspective (however, auxiliary memory 220 may still be organized with contiguous linear memory address, such addresses being used by a cache controller to identify the data location to be used for data access). Commonly, selected elements of operational memory 232 will be mapped to cached data 222. As illustrated, memory location M−2 of operational memory has been mapped to entry N−1 of cached data 222, and memory location 1 of operational memory 232 has been mapped to entry 1 of cached data 222. It will be understood that the illustrated mapping is a randomly-chosen representation, and the mapped operational memory locations can be mapped in multiple arrangements to cached data entries in accordance to the caching scheme implemented (for example, one of fully-associative scheme, direct mapped scheme, set-associative scheme). The order of assignment or use of the cached data entries is not necessarily any order in relation to their position in auxiliary memory 220 and is not necessarily any order in relation to their position in primary memory 230. For example, in system 202, the mapping “A” is intended to represent that entry N−1 is “older” than mapping “B” for entry 1. Age references such as “A” and “B” may be stored as part of on-die metadata by the cache controller, and are illustrated here in auxiliary memory 220 in accordance with implementations where age references are stored in auxiliary memory itself. Thus, the entries and mappings of auxiliary memory 220 should be understood as dynamic, and occurring in accordance with a management mechanism to cache and evict entries such as executed by one of cache controller and auxiliary memory 220.

Typically, the entries of auxiliary memory 220 will be of the same granularity as the memory locations within primary memory 230. Reference to “memory location” herein can refer generically to a starting address in memory for a portion of data to be accessed (such as a page), or to individually-addressable locations in memory (such as a byte), referring to the issuance of a command to identify a location in memory to perform an operation. For example, in one embodiment, the memory locations of primary memory 230 reference pages of data, where each entry identifies storage for a page of data. A “page” as used herein refers to the allocation unit with which memory is allocated by the operating system to applications. For example, in many computer systems a page is a 4 Kilobyte block of memory. The page size represents the largest amount of contiguous data in system memory that is likely to all relate to a specific software operation. Thus, memory locations of operational memory 232 can be a page, and entries of cached data 222 correspondingly can store a page. In one embodiment, a different allocation unit can be used, such as a cacheline or other allocation unit.

Typically, the entries of auxiliary memory 220 will be writeable at the same granularity as the memory locations within primary memory 230. For example, in one embodiment, the memory locations of primary memory 230 may be writeable at byte granularity (thus allowing a single byte of data to be written to memory without needing to know the data stored in adjacent bytes to the byte to be written). Thus, memory locations of operational memory 232 may also be writeable at byte granularity. In one embodiment, a different write granularity unit can be used, such as a cacheline or other unit. Fine-grained write granularity, such as byte write granularity may also be implemented by memory controllers for auxiliary memory operational memory, in an abstracted manner, such as by a memory controller (such controller being either internal or external to the memory) reading a larger unit of data (such as cache-line) from the memory location, replacing the contents of the chosen byte of data with the value to be stored, and re-writing the entire larger unit of data.

In one embodiment, the data store of the cache in auxiliary memory 220 can be considered near memory and the main memory store of primary memory 230 can be considered far memory. Auxiliary memory 220 has faster access time than primary memory 230. The faster access time can be because auxiliary memory 220 includes different memory technology, has a faster clock speed, has lower signal fan-out, or is architected to have less access delay with respect to host 210 (e.g., by being physically located with a shorter path), or a combination of these. Auxiliary memory 220 is used to hold a copy of selected data elements from primary memory 230, and these copies may be referred to as “cached data”. As illustrated, cached data 222 of auxiliary memory 220 includes N elements or memory locations, and operational memory 232 of primary memory 230 includes M memory locations, where M is greater than N, generally by an order of magnitude or so. Auxiliary memory 220 as near memory would typically store more commonly used data to reduce the access time to the more commonly used items. As memory systems are generally agnostic to the actual meaning and use of the data, such data can also include the instruction code of software such as OS and applications.

As illustrated, host 210 includes cache metadata 212. Host 210 can include a cache controller that manages and uses cache metadata 212. In one embodiment, the cache controller manages metadata 212 for the data of all cache entries held as cached data 222. Thus, as illustrated, cache metadata 212 includes N elements corresponding to the N elements of cached data 222. Metadata 212 can include information such as tag information, or other metadata as is known in the art. Metadata 212 can be stored as a table or other form in CMOS data array or other data storage structure. In one embodiment, the cache controller stores flags 214 with metadata 212. For example, every metadata entry can also include a high compressibility (HC) flag 214. HC flags 214 can indicate for each of the N elements whether the data is highly compressible.

As mentioned above, cache entries and memory locations can allocate an amount of storage in accordance with an allocation configuration for system 202. Such an allocation can be for a 4 KB page size. In one embodiment with a 4 KB page size, the relatively large size of a page allows system 202 keep HC metadata pertaining to a significant amount of data on-resource (such as on-die) at host 210. For example, for an implementation where HC flag 214 is a single bit to indicate AZ data, host 210 can potentially store metadata corresponding to each page of a multi-Gigabyte memory structure using, for example, only a single Megabit of on-die HC data storage. It will be understood that other configurations are possible.

The store of HC flags 214 could be referred to as a “cheat sheet cache,” or a “cribbing cache,” referring to the concept of having a set of notes that contains not the data itself, but a brief summary of the data where possible (for example, storing a single flag indicating that ‘all these bytes are zero’ requires vastly less storage than storing 4096 individual zero bytes of data). HC flags 214 can identify the data without the need for host 210 to access the data in either primary memory 230 or auxiliary memory 220. For example, consider the case where HC flags 214 include single-bit flags to indicate whether or not the data at specific entries of cached data 222 and correspondingly the memory locations of operational memory 232 is either AZ (all-zero) data or not. Observation of computer system behavior with real operating systems reveals is that a significant proportion, approximately 10%, of the pages in memory contain zero data values and nothing else. There are multiple occasions where pages are zeroed, including on system boot, on memory allocation or reallocation, on preparation of blank data structures, or on other occasions. In one embodiment, host 210 (e.g., via a cache controller) can identify a memory location as including AZ data, and eliminate the need in certain circumstances from accessing memory 220 or 230 in response to an access request, because it is already known from HC flag 214 that the value of the data is AZ.

System 202 has the potential to yield memory subsystem power savings, as well as increasing memory subsystem performance, by multiple percentage points. The power savings and performance improvements could improve by an amount comparable to the amount of data that is AZ. For example, a system with 10% AZ data that utilizes HC flags may yield up to 10% performance improvements as compared to a system that does not use HC flags. The benefits of system 202 are expected to be most visible as a boost in memory performance during system events such as application loads, with a direct impact on user experience of system responsiveness. It will be understood that the use of HC flags 214 is distinct from traditional “zero compression” techniques which replace zero-data with compressed data that gets stored and transferred in place of the data. Such techniques still require the transfer of data, and while transferring less data can provide power improvements, such techniques do not improve, and in some cases actually negatively impact, performance with respect to access times. It will be understood that the use of HC flags 214 is distinct from schemes that hold a HC flag as an alternative to storing the zero-data in the off-resource memories. Such techniques that hold a flag as an alternative to storage the data in an off-resource memory are ill-equipped to handle the case where a small portion of the data of a location is written with a non-zero value during system operation.

It will be understood that while AZ data is specifically discussed, the application of HC flags 214 is broader than AZ data. In one embodiment, every HC flag 214 includes multiple bits, which can allow host 210 to identify multiple different highly compressible data patterns, such as AZ data, all-ones data, all-fives, or other data patterns including more complex data patterns. It will be understood that in system 202, for all data identified by an HC flag 214, primary memory 230 stores the data, and auxiliary memory 220 stores a copy of the data (however, it should be noted that primary memory 230 may from time to time contain stale data, in accordance to established cache write-back techniques being applied to the cache formed using auxiliary memory 220). Primary memory 230 and auxiliary memory 220 maintain the data consistent across read and write accesses in accordance with known or proprietary techniques. Storing the data consistently across primary memory 230 and auxiliary memory 220 differs from typical compression techniques that store the compressed data instead of a copy of the data. System 202 stores the copy of the data, and additionally uses flags 214 to determine if the data pattern is known.

Host 210 stores HC flags 214 locally, which enables the cache controller to access the HC information without having to perform inter-device I/O to determine if the data is highly compressible. The fact that the flags are stored locally allows the cache controller to return fulfillment of a memory access request in certain circumstances without accessing the actual data. There are several common scenarios where the on-resource or on-die record of HC flags 214 allows host 210 to avoid costs (such as latency, power, bandwidth, bottlenecks, bank contention) of access to cached data 222.

In one scenario, a processor or CPU or other processing component of host 210 requests to read part of a cache entry. If the cache controller determines that HC flag 214 for the cache entry indicates a known highly compressible data pattern, the cache controller can immediately supply the requested data (such data being the portion of the highly compressible data pattern which was requested to be read). The cache controller can provide the data without accessing the cache entry, which avoids the latency penalty of fetching the requested part of the data from memory.

In another scenario, the processing component requests to write data into cached data 222. If the data to be written has a data pattern that matches or is consistent with the data pattern indicated by HC flag 214, the cache controller can simply ignore the write, knowing that it will not actually change the data values stored. Consider an example where the HF flag indicates a series of bytes of increasing values, starting at 0x00, and the data to be written includes a single byte 0x07 to an offset of 7 in the data page. In such an example, the single byte matches the value of the HC data for the single byte location to be written, which would allow ignoring the write. In one embodiment, such a single byte of value 0x07 can be considered consistent with a series of bytes of increasing values, starting at 0x00, even if the single byte is not considered to “match” the series of bytes of increasing values. Thus, in one embodiment, comparison for consistency or matching does not necessarily imply an expectation of the write data being the entire HC pattern.

For an implementation where a data pattern indicates a specific data type, and for an implementation where different portions of data can be separately identified by multi-part flag, a data pattern can be required to match each and every piece of data to be written by the request. In one embodiment, the cache controller in such a scenario does not mark the cache entry as dirty, which can avoid the need for the data to be written back to primary memory 230 on eviction from auxiliary memory 220. It will be understood that such functionality could not be attained in a regular system without having first read the portion of the location to be overwritten in auxiliary memory 220 and compared it with the data to be written. As will be understood, such a task is highly inefficient. Thus, in one embodiment, HC flag 214 enables the cache controller to determine that a memory access is superfluous and simply drop the access request.

In another scenario, auxiliary memory 220 reallocates a cache entry of cache data 222. If in reallocation the data stored in cached data 222 prior to the reallocation and the data to be stored after the reallocation have matching HC flags 214 indicating the same data pattern, auxiliary memory 220 does not need to update the data stored in cached data 222 with data of new allocation, as it is identical to the data of the previous allocation. Such cases may be rare overall during operational use of system 202, but may occur with some frequency in specific scenarios, such when an OS zeroing process occurring in bursts as memory is freed up (specifically referring to AZ data). Thus, HC flag 214 can provide a mechanism that, in cases where large quantities of zero pages are being formed, allows auxiliary memory 220 to operate at the same high speed as if all data storage was implemented on-resource at host 210. Applying a similar mechanism in a traditional system would require for each write to read the portion of the location to be overwritten in auxiliary memory 220 and compare it with the data to be written, which would be a highly inefficient process except in the unusual case of an auxiliary memory where a write cycle consumed an order of magnitude greater energy than a read cycle. However, where the HC data is available by reading a single on-resource flag, the energy for this read cycle (particularly where performed as part of an existing cache metadata fetch) may be several orders of magnitude smaller than the write cycle that can be omitted where the new data to be written matches the existing HC data.

Thus, in certain scenarios, HC flags 214 can enable a cache controller to preserve the state of HC flag 214 for an entry during cache entry reallocation if data of the same pattern is to be stored in a corresponding entry of cached data 222 (such as when data of the same pattern has been fetched from operational memory 232 for the purpose of cache fill). HC flags 214 can also enable cache controller to report a write as being fulfilled, without performing the write (partial write dropping) or without dirtying the cache entry, when the data to be written matches the identified data pattern of HC flag 214.

Such mechanisms can be understood as different from traditional compression techniques. Traditional compression techniques still suffer costs of power, latency, and bandwidth of fetching cache data for entries that contain known patterns (e.g., AZ data). Traditional compression techniques also suffer costs of power and bandwidth to overwrite cache data of a known pattern with the identical pattern (e.g., overwriting zeros with ‘new zeros’). Traditional compression techniques also suffer costs of power and bandwidth for both near memory and far memory to write known patterns to far memory when a write request does not change the data pattern.

Consider the following analogy for near memory, far memory, and HC flags. A company stores official documents offsite in a storage building, which is offsite relative to a building where most of the people work. The company has a rule that the official documents must physically remain in the offsite storage building. Anyone wanting to see the official documents must visit them in the offsite storage building. It is permitted to modify the original document, but only within the confines of the offsite storage. An executive determines that there are some documents that people are frequently accessing, while most documents are not accessed regularly. The executive arranges for a photocopy of the commonly accessed documents to be held in a basement room of the onsite building, saving the trip to the offsite storage. A person wanting a document in that room will still have to go down to the basement, but the trip would be shorter than going to the offsite storage. Perhaps the executive even arranges a system to allow modification of the copy of the common documents held in the basement room, which are then occasionally sent to the offsite storage building to replace the originals. Such an approach would cunningly still adhere to the “official documents must physically remain in the offsite storage building” rule, given that the modified copy document only becomes the “official” document once it arrives at the offsite storage building to replace the original.

In this analogy, the offsite storage building is far memory and holds the official copy of all documents. There may be a certain inconvenience and delay in accessing documents stored there. The basement room is near memory and functions as a cache containing some of the official documents. There is still a delay to go to the basement room, but it is faster and more convenient than the offsite storage. Thus, the creation of the ‘cache’ of commonly-used documents basement room has not changed the status of the offsite storage, but allows faster access to commonly-used documents. The modification of documents at the basement room is like writing a cache entry, which then gets synchronized back out to far memory. In accordance with the analogy, the far memory is also considered the main memory, as it is able to hold the official copy of all documents, whereas the basement is neither large enough to accommodate a copy of all document, nor permitted to be the official copy.

Consider now that the executive decides to keep a list of information for all documents stored in the basement room right at the front desk of the building. Instead of needing to go to the basement or go offsite, a person can find out certain information about certain documents just by looking at the list at the front desk. Such a list can indicate, for example, which part of which box the documents are located, and may be even a map of the basement room to indicate specifically where the document can be found. Such a list can be comparable to cache metadata. If the list includes an additional column to indicate that the document was a blank document, or unreadable, or some other common pattern of data, a person would not even need to go down to the basement to access the document. Such a column of data can be comparable to HC flags 214, which allows the cache controller to avoid effort to access to the document simply by considering the information in the flag.

Consider also how this analogy may apply to the write process. A person who has been instructed to make a certain document unreadable will get ready to enquire at the front desk as to whether and where in the basement the copy of the document is held, and, assuming it is held in the cache, plan to go to the basement, make the copy of the document unreadable by spilling coffee over it, and then send the ruined copy to the offsite storage building to become the new original. However, should the person, on inquiring at the front desk be told, based on this additional column, that the document copy held in the basement is unreadable, they will know that they can report their task as completed without expending the additional effort of descending to the basement, locating the document copy, or even preparing the coffee.

In one embodiment, auxiliary memory 220 includes DRAM data storage structures and primary memory 230 includes DRAM data storage structures. Primary memory 230 can include a traditional DRAM memory module or modules as main memory. Auxiliary memory 220 can include a smaller, faster DRAM device or DRAM module as a cache for some of the data from main memory. In one embodiment, auxiliary memory 220 includes DRAM memory, and primary memory 230 includes 3DXP memory. 3DXP memory is understood to have slower, but comparable, read times as compared to DRAM, and significantly slower write times as compared to DRAM. However, 3DXP is nonvolatile and therefore does not need to be refreshed like DRAM, allowing a lower standby power. A memory subsystem in accordance with system 202 can include 3DXP primary memory 230 and a DRAM auxiliary memory 220. Overall power usage will be improved, and access performance should be comparable.

In place of 3DXP, other memory technologies such as phase change memory (PCM) or other nonvolatile memory technologies could be used. Nonlimiting examples of nonvolatile memory may include any or a combination of: solid state memory (such as planar or 3D NAND flash memory or NOR flash memory), storage devices that use chalcogenide phase change material (e.g., chalcogenide glass), byte addressable nonvolatile memory devices, ferroelectric memory, silicon-oxide-nitride-oxide-silicon (SONOS) memory, polymer memory (e.g., ferroelectric polymer memory), ferroelectric transistor random access memory (Fe-TRAM) ovonic memory, nanowire memory, electrically erasable programmable read-only memory (EEPROM), other various types of non-volatile random access memories (RAMs), and magnetic storage memory. In some embodiments, 3D crosspoint memory may comprise a transistor-less stackable cross point architecture in which memory cells sit at the intersection of wordlines and bitlines and are individually addressable and in which bit storage is based on a change in bulk resistance. In particular embodiments, a memory module with non-volatile memory may comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at www.jedec.org).

FIG. 2B is a block diagram of an embodiment of a system illustrating use of a high compressibility indication. System 204 represents system components of a multilevel memory in accordance with an embodiment of either or both of system 100 of FIG. 1 and system 202 of FIG. 2A. Alternatively, system 204 represents an alternate embodiment of high compressibility indication. Controller 240 represents components of the hardware platform for system 204, and more particularly components of a cache controller. Controller 240 can include interface components and processing logic. Controller 240 can manage access to auxiliary memory 250. While not specifically shown, auxiliary memory 250 stores a partial copy of data of a primary memory.

Auxiliary memory 250 includes memory locations 260, which store data to be used in the operation of a host controller (not specifically shown) of system 204. Memory locations 262, 264, and 266 represent the stored data of various cached entries. While labeled as “memory locations 260,” it will be understood that the memory locations are entries mapped to memory locations in main memory. In one embodiment, memory locations 260 include X portions or segments of the data. In one embodiment, the X portions are not relevant to the operation of controller 240, at least with respect to the use of HC flags, such as where a single HC flag is used for each of memory locations 262, 264, and 266. In one embodiment, memory locations 260 represent pages of memory. In one embodiment where a page is 4 KB, X equals 4 with four separate 1K portions. In one embodiment, HC flags can separately identify high compressibility for each portion, such as where four HC flags are used for each of memory locations 262, 264, and 266. In one embodiment, the X separate portions are not each abutting continuous pieces of data, and may be some other arrangement such as where X is 2 and the first portion contains every odd KB of data (such the first and the third KB of data of a page) and where the second portion contains every even KB of data (such the second and the fourth KB of data of a page), or some other interleaving approach.

In one embodiment, controller 240 includes a data store of HC indications 242, which can also be referred to as flags. The flags are or include one or more fields of data or fields of indication. For purposes of identification only, and not by way of limitation, HC indications 242 refers collectively to multiple separate flags. Specifically, HC indications 242 is illustrated including flag 244 and flag 246. In one embodiment, HC indications 242 are part of a cache metadata store of controller 240. In one embodiment, HC indications 242 are a store of metadata separate from other cache metadata. HC indications 242 include multiple flags. In one embodiment, controller 240 includes an HC indication 242 for every entry or memory location 260 of auxiliary memory 250.

In one embodiment, HC indications 242 are single bits. In one embodiment, as illustrated in system 204, HC indications 242 can include multiple bits. HC indications 242 can include a bit for every portion of data of the memory locations, which can subdivide the HC indication for different portions of each memory location 260. As illustrated, flag 244 corresponds to memory location 262, and flag 246 corresponds to memory location 266. In one embodiment, the order of HC indications 242 is the same as an order of entries in auxiliary memory 250.

As stated above, HC indications 242 can include multiple bits. The multiple bits can be multiple bits per flag, one bit per portion P of a memory location 260. In one embodiment, the multiple bits can be multiple bits per memory location 260, or multiple bits per portion P, where the multiple bits B2:B0 indicate a highly compressible data pattern. Such an implementation allows the encoding of one of seven different patterns in addition to a ‘no HC data’ encoding. While three “data pattern” or “data type” bits are illustrated, it will be understood that the data type bits can include any one or more bits, depending on the implementation of system 204. Different numbers of bits and different permutations of bit values can represent different highly compressible data patterns. There will be practical limits on how many bits should be included, based on storage and processing resources, as well as a number of expected common patterns of bits and the expected use cases of the system. In one embodiment, system 204 implements multiple bits with one bit per portion P, or multiple bits to identify a bit pattern, and not both. As illustrated, system 204 can implement either multiple bits with one bit per portion P, or multiple bits to identify a bit pattern, or a combination of the two.

In one embodiment, controller 240 can maintain an HC indication 242 for a memory location 260 for as long as the data for the memory location is highly compressible data. As soon as the data is not highly compressible, in one embodiment, controller 240 clears the HC indication. In one embodiment, controller 240 stores HC indications 242 together with cache metadata. In one embodiment, controller 240 stores HC indications 242 as a separate memory structure from other metadata. In one embodiment, the metadata can include a cache tag, a valid indicator, a dirty indication, or other metadata, or a combination. In one embodiment, HC indications 242 are on die with controller 240. An HC indication being on die with controller 240 refers to the HC indication being stored on a die or chip or substrate of the controller. More generally, an HC indication can be on resource with controller 240, which could be on die with the controller circuit or with the same packaging as the controller circuit, and accessible much faster than access to the data represented by the HC indication. Controller 240 can in turn be on resource with a memory controller or a processor device, or both.

In one embodiment, system 204 can generate HC indications for memory locations 260 on-the-fly during the fetch of data from main memory into the cached data (often referred to as a ‘cache fill’ operation). Such generation does not incur additional data accesses. In one embodiment, HC indications 242 include flag information that indicates high compressibility information for only a portion of memory location 260. In one embodiment, different flags for different portions of memory locations 260 can be considered separate flags, where the indications or flags are for a different granularity than the size of the page represented by memory location 260 or different than the size of data for entries within caching auxiliary memory 250.

In one embodiment, for a write request, controller 240 can separately manage flags for different portions of data. When the write request is to the specific portion that indicates highly compressible data, in one embodiment, controller 240 can manage the portions separately with respect to the write, based on HC indications 242. For example, consider a write to memory location 262 to portion P[0]. If flag 244 indicates that portion P[0] has highly compressible data, but portion P[1] does not, and the write contains the same values to be written as the values already present at portion P[0], controller 240 can avoid a write to portion P[0] and perform a write to portion P[1].

As described, the multiple bits such as B2:B0 may indicate a highly compressible data pattern (such a scheme allowing the encoding of one of seven different patterns in addition to a ‘no HC data’ encoding). In one embodiment, such data patterns may be chosen automatically by controller 240, such as by observation of the run-time occurrence of specific data patterns from a larger selection of potential data patterns, allowing a system to on one occasion determine that it is favorable to assign various values of HC flags to various data patterns representing silence in an audio stream, and at other times to assign those same values of HC flags to various data patterns representing white in a graphics image (with such an assignment being reset at system boot time or cleared periodically with invalidation of an existing data pattern and clearing of any flags referring to such pattern).

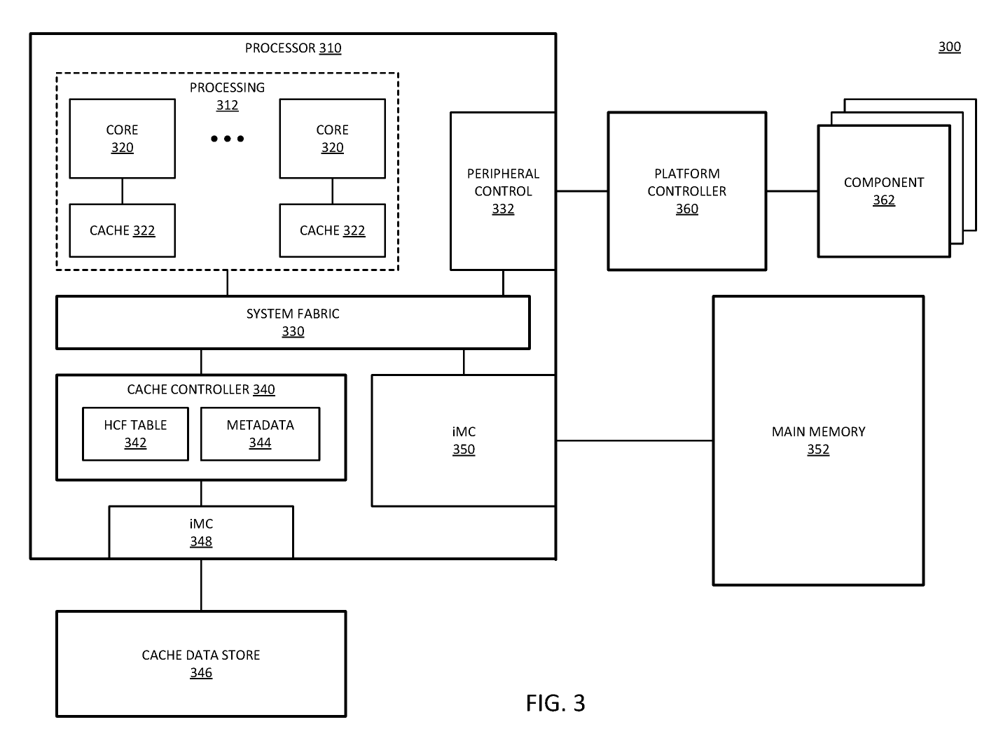

FIG. 3 is a block diagram of an embodiment of a memory subsystem with an integrated near memory controller and an integrated far memory controller. System 300 represents components of a multilevel memory system, which can be in accordance with an embodiment of system 100 of FIG. 1, system 202 of FIG. 2A, or system 204 of FIG. 2B. System 300 specifically illustrates an integrated memory controller and integrated cache controller. The integrated controllers are integrated onto a processor die or in a processor SOC package, or both.

Processor 310 represents an embodiment of a processor die or a processor SOC package. Processor 310 includes processing units 312, which can include one or more cores 320 to perform the execution of instructions. In one embodiment, cores 320 include processor side cache 322, which will include cache control circuits and cache data storage. Cache 322 can represent any type of processor side cache. In one embodiment, individual cores 320 include local cache resources 322 that are not shared with other cores. In one embodiment, multiple cores 320 share cache resources 322. In one embodiment, individual cores 320 include local cache resources 322 that are not shared, and multiple cores 320 include shared cache resources. It is to be understood that in the system shown, processor side cache 322 may store both data and metadata on-die, and may thus neither participate in, nor implement, the highly compressible (HC) mechanism described in relation to other elements of system 300.

In one embodiment, processor 310 includes system fabric 330 to interconnect components of the processor system. System fabric 330 can be or include interconnections between processing components 312, peripheral control 332, one or more memory controllers such as integrated memory controller (iMC) 350 and cache controller 340, I/O controls (not specifically shown), graphics subsystem (not specifically shown), or other component. System fabric 330 enables the exchange of data signals among the components. While system fabric 330 is generically shown connecting the components, it will be understood that system 300 does not necessarily illustrate all component interconnections. System fabric 330 can represent one or more mesh connections, a central switching mechanism, a ring connection, a hierarchy of fabrics, or other topology.

In one embodiment, processor 310 includes one or more peripheral controllers 332 to connect off resource to peripheral components or devices. In one embodiment, peripheral control 332 represents hardware interfaces to a platform controller 360, which includes one or more components or circuits to control interconnection in a hardware platform or motherboard of system 300 to interconnect peripherals to processor 310. Components 362 represent any type of chip or interface or hardware element that couples to processor 310 via platform controller 360.

In one embodiment, processor 310 includes iMC 350, which specifically represents control logic to connect to main memory 352. iMC 350 can include hardware circuits and software/firmware control logic. In one embodiment, processor 310 includes cache controller 340, which represents control logic to control access to cache memory data store 346. Cache data store 346 represents the storage for a cache, and may be referred to herein simply as cache 346 for convenience. Cache controller 340 can include hardware circuits and software/firmware control logic. In one embodiment, processor 310 includes iMC 348, which specifically represents control logic to connect to cache 346. iMC 348 can include hardware circuits and software/firmware control logic, including scheduling logic to manage access to cache 346. In one embodiment, iMC 348 is integrated into cache controller 340, which can be integrated into processor 310. In one embodiment, cache controller 340 is similar to iMC 350, but to interface to cache 346, which acts as an auxiliary memory, instead of connecting to main memory 350. In one embodiment, cache controller 340 is a part of or a subset of control logic of memory controller 350.

Cache controller 340 interfaces with memory side cache storage 346 via iMC 348. In one embodiment, cache controller 340 includes metadata 344, which represents memory side cache metadata storage. Metadata 344 can be any embodiment of cache metadata as described herein. In one embodiment, cache controller 340 includes HCF (high compressibility flag) table 342. While specifically identified as a table, it will be understood that the HCF data can be stored in any type of memory structure at cache controller 340 which allows selective access for different entries. In one embodiment, HCF table 342 is part of metadata 344. In one embodiment, HCF table 342 can be implemented separately from metadata 344. HCF table 342 can be understood as a memory structure of cache controller 340 dedicated to the storage of high compressibility indications or representations. It will be understood that cache controller 340 has fast, local, low-power access to HCF table 342 and metadata 344. The access to HCF table 342 is significantly faster and lower power than access to cached data in cache 346.

The processor side cache differs from the memory side cache in that processor side cache is typically very fast, holds both metadata and data locally, and located very close to the processing cores 320. Caches 322 will typically be smaller than (do not hold as many entries as) cache 346. Caches 322 can include cache controllers with metadata similar to cache controller 340 and metadata 344. Thus, the application of high compressibility flags could also be applied to processor side cache as well as to memory side cache. However, given that processor side caches 322 are typically located very close with low access delay to cores 320, and metadata for caches 322 does not have significantly faster access than the cache data storage, such an implementation may not provide much performance boost. Thus, while possible to implement, its implementation may not yield significant performance improvements.

With memory side cache, cache controller 340 is implemented on processor 310, and accesses to HCF table 342 may be made without having to perform I/O off of processor 310. In one embodiment, the cache data store 346 is located off die or off resource from processor 310. In one embodiment, cache data store 346 is located on resource to processor 310, and implemented in an on resource memory storage that has slower access than HCF table 342. For example, HCF table 342 can be implemented in registers or a small, fast memory structure, and cache 346 can be implemented in a slower memory resource such as STT memory, or on resource memristor memory, or other memory structure.

In one embodiment, during the process of accessing data from main memory 352, such as allocating entries in cache memory or data store 346 to store data from main memory 352, iMC 350 or cache controller 340 or both identify data as having a highly compressible data pattern. In such a case, cache controller 340 can store HCF information for the cache entries in HCF table 342. It will be understood that identification of certain highly compressible data patterns already occurs in some systems, which means that cache controller 340 can implement HCF management with little overhead.

Additional embodiments may be derived by re-assignment of the roles of the elements of system 300. In one such embodiment, iMC 350 and main memory 352 may represent a large storage-based virtual memory; cache data store 346 may represent the system DRAM memory and elements of cache controller 340 operation including metadata 344 may be implemented by system software (such as a host OS) in place of hardware. In such an implementation, HCF table 342 may be implemented in hardware, with HCF table 342 receiving notification from system software regarding HC data, for example receiving a notification that an entire page has been zeroed or receiving a notification that a page of zero data has been fetched from the storage-based main memory. In such an embodiment, HC indications present in the HCF table may allow certain requests directed towards system DRAM memory acting as cache data store 346 to be fulfilled without requiring access to that memory.

In another such embodiment, iMC 350 and main memory 352 may be unused; cache data store 346 may represent the entire system DRAM memory and elements of cache controller 340 operation including metadata 344 may be implemented by fixed hardware assignment (such as a 1:1 mapping between cache data store 346 addresses and system memory map addresses). In such an implementation, HCF table 342 may be implemented in hardware, with HCF table 342 receiving notification from system software regarding HC data, in particular receiving a notification that an entire page has been zeroed or otherwise filled with HC data. In such an embodiment, HC indications present in the HCF table may allow certain requests directed towards system DRAM memory of cache data store 346 acting as system memory to be fulfilled without requiring access to that memory.

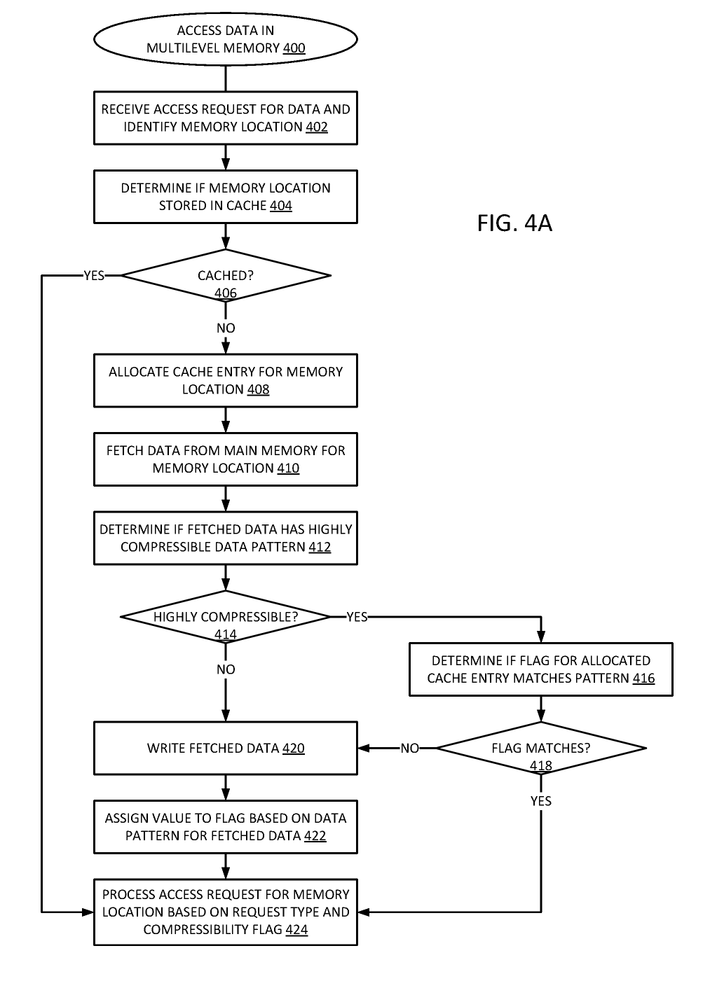

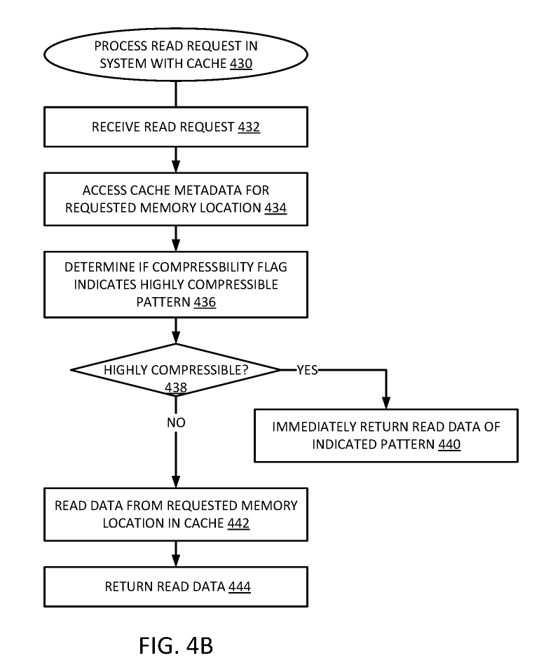

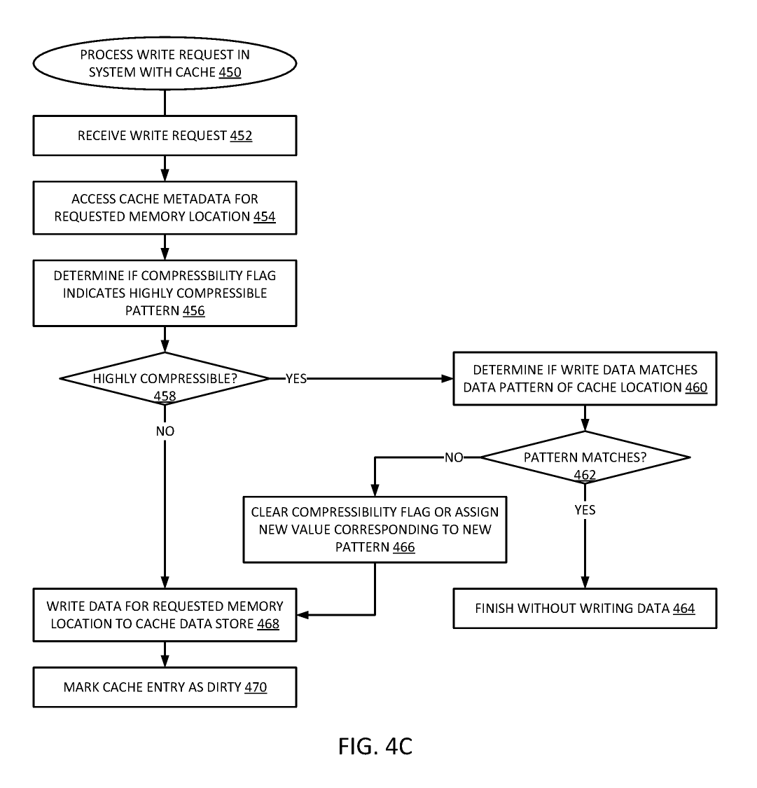

FIG. 4A is a flow diagram of an embodiment of a process for accessing data in a multilevel memory. Process 400 for accessing data in a multilevel memory can occur within an MLM system in accordance with any embodiment described herein. During execution of one or more processes, a processor generates an access request for data from a memory location or memory address. The access request can be, for example, a read access request or a write access request. A cache controller receives the access request from the processor or from a higher level cache, and identifies the memory location requested from address information in the request, 402. In one embodiment, the cache controller determines if the memory location is stored in cache, 404.

In one embodiment, if the memory location is cached, 406 YES branch, the cache controller can process the access request based on the request type (e.g., read or write) and a compressibility flag, 424. In one embodiment, if the memory location is not cached, 406 NO branch, the cache controller allocates a cache entry for the memory location, 408. The cache controller fetches the data from main memory corresponding to the identified memory location, 410, for storage in the cache storage.

In one embodiment, the cache controller determines if the fetched data has a highly compressible data pattern, 412. If the data is not highly compressible, 414 NO branch, the cache controller can write the fetched data in the cache storage, 420. In one embodiment, the cache controller assigns a value to the flag for the cache entry based on the data pattern for the fetched data, 422, assigning a given value such as “0” where there is a lack of any such pattern such as in the case where the 414 NO branch was taken. Such a flag can be any type of high compressibility flag or HC indication described herein.

If the data is highly compressible, 414 YES branch, in one embodiment, the cache controller determines if the flag for the highly compressible data pattern of the fetched data matches a flag that is already allocated or provisioned for the entry in which the fetched data is to be stored, 416. In one embodiment, if the flag does not match, 418 NO branch, the cache controller writes the fetched data, 420, and assigns a flag to a value to represent the HC pattern present in the fetched data, 422, as described above. In one embodiment, the flag will not match because the data, although highly compressible, has a different highly compressible data pattern (e.g., overwrite all zeros data with all fives data) than the highly compressible data already stored at the memory location in the cache. In one embodiment, if the flag does match, 418 YES branch, the cache controller can avoid writing the data, and simply process the data access request, 424. It will be understood that if the pre-existing flag value for the allocated cache entry matches the flag value determined for the pattern of the fetched data, there is no need to overwrite the cache entry to “replace” the current entry with the same data. Thus, allocation of a cache entry can include simply maintaining a value of the flag and not overwriting the entry when the current entry matches the fetched data. Such an allocation can include reallocation of system or main memory address information, without affecting the stored data or compressibility flag.

The cache controller can process the access request in accordance with the compressibility flag and the request type, 424. The cache controller processes the access request in the case that the memory location is not cached, 406 NO branch, and also in the case that a flag for an allocated cache entry matches a pattern of data stored at the memory location, 418 YES branch, and also in the case that the cache controller assigns a value to a flag, 422. The processing of the request includes the cache controller returning fulfillment of the access request based on the request type and the compressibility flag. FIGS. 4B and 4C below provide further details for embodiments of processing read and write requests, respectively. In accordance with process 400, a cache controller can provide performance improvements to data access. Consider a scenario where a page of zeros is fetched from main memory into the cache into a cache entry that is already all-zeros, over-written with zeros by the CPU, and then evicted back to main memory. Traditional operation of a memory would require operations at every point of the scenario. As described herein, the cache controller can avoid the overwrite of data in the cache when the fetched and cached data are both flagged as being AZ, can drop the write by the CPU because the cached data is already AZ, and can drop the write-back operation of an eviction request because the data in main memory is already AZ. The use of the HC flag can thus allow a cache controller to avoid many different accesses to memory. Thus, in one embodiment with the HC flags, the cache controller can return fulfillment of a memory access request based solely on the HC flag, without accessing or instead of accessing the memory location in near memory.

FIG. 4B is a flow diagram of an embodiment of a process for processing a read access request in a system with a high compressibility flag. Process 430 for processing a read request is one embodiment of a processing a memory access request based on a compressibility flag in accordance with block 424 of process 400. In one embodiment, the cache controller receives a read request, 432, and accesses the cache metadata pertaining to the requested memory location, 434.

In one embodiment, the cache controller determines if a compressibility flag for the memory location indicates a highly compressible data pattern, 436. In one embodiment, if the flag does not indicate a highly compressible data pattern, 438 NO branch, the cache controller can read the data from the entry in cache pertaining to the requested memory location, 442. It will be understood that such an operation is the traditional approach that will always be performed in traditional systems. The cache controller can return the read data accessed from the cache, 444.

In one embodiment, if the flag indicates a highly compressible data pattern, 438 YES branch, the cache controller can return fulfillment of the read request without needing to access the actual data. Instead, the cache controller can simply provide the requested data to the processor, based on its knowledge of the representation of the actual data as indicated by the flag. In one embodiment, the cache controller can include an on resource store of the data patterns that can be flagged, such as in registers, and return the data in response to the request. Thus, the cache controller can immediately return the read data of the indicated data pattern without accessing the cache memory data, 440.

In contrast to the traditional approach, the use of a high compressibility flag can enable the cache controller to avoid read data traffic, and provide faster response latency in the case of a read request to a page or potentially to a part of a page that contains highly compressible data.

FIG. 4C is a flow diagram of an embodiment of a process for processing a write access request in a system with a high compressibility flag. Process 450 for processing a write request is one embodiment of a processing a memory access request based on a compressibility flag in accordance with block 424 of process 400. In one embodiment, the cache controller receives a write request, 452, and accesses the cache metadata pertaining to the requested memory location in cache, 454.

In one embodiment, the cache controller determines if a compressibility flag for the memory location indicates a highly compressible data pattern, 456. In one embodiment, if the flag does not indicate a highly compressible data pattern, 458 NO branch, the cache controller can write the data for the requested memory location to the cache data store, 468. As part of writing the data to cache, the cache controller will mark the cache entry as dirty, 470, which will cause the contents of the cache data store to be synchronized with main memory by being written back out to memory as part of an eviction or scrubbing process.

In one embodiment, if the flag indicates a highly compressible data pattern, 458 YES branch, the cache controller determines if the write data matches a data pattern of data already stored in the cache entry, 460. In one embodiment, the data patterns will not match even if the data is still highly compressible, such as in the case of overwriting data of one highly compressible pattern with data of a different highly compressible pattern. Thus, the lack of a matching pattern does not necessarily mean that the data is not highly compressible. If the highly compressible data patterns do not match, 462 NO branch, in one embodiment, the cache controller clears the compressibility flag, 466. In one embodiment, provided that sufficient write data has been provided to correspond to the full portion of data referenced by the compressibility flag the cache controller assigns a value to the compressibility flag corresponding to the new highly compressible data, 466. In one embodiment, the comparison of the compressibility flag to data includes a comparison of only a portion of data, and a flag or flag bit that indicates the high compressibility of the portion of the data. In one embodiment, the cache controller then returns to the traditional write path of overwriting the cache entry and marking the entry as dirty, 466, 468 and 470. If the highly compressible data pattern of the cache entry and the write data do match, 462 YES branch, in one embodiment, the cache controller finishes without writing the data, 464. It will be understood that there is an access penalty to overwriting the cache entry without a comparable benefit, which can be avoided as illustrated at 464.

In accordance with process 450, a cache controller can return acknowledgement of a write request without marking a cache entry dirty for the memory location. In one embodiment, the cache controller can manage portions of data separately. Thus, when the write request is only for a portion of the data of the identified memory location, the cache controller can avoid a write for a portion based on a high compressibility flag for the portion.

It will be noted that despite the potential for a series of write requests to result in a memory location containing highly compressible data, in many types of systems, the highly compressible (HC) flag can never be set for process 450. This is a characteristic of write requests generally containing less data than need to write an entire memory location (and less data than needed to write an entire portion of a memory location where HC flags are assigned per-portion). Process 450 is able to identify cases where write requests have ruined a data pattern of a memory location thus rendering the data of that location no longer highly compressible and warranting that the HC flag be cleared, but is generally unable in its basic form to identify cases where a group of write requests together result in the entire amount of memory location referred to by a HC flag (such as an entire memory location and such as an entire portion of a memory location in the case of per-portion HC flags) newly containing data that may be represented by a HC data pattern. It will be understood that in some systems, a single write request may contain sufficient data to write an entire portion of a memory location, and thus assign a value to the compressibility flag corresponding to the new highly compressible data, 466. In some systems, it would be possible in a variation of process 450 to analyze a series of write requests to identify cases when the entirety of a memory location (or the entirety of a portion of a memory location where per-portion HC flags are used) has been filled with highly compressible data, and to thus assign a value to the compressibility flag corresponding to the new highly compressible data received 466, where the data has been received over the series of write requests.

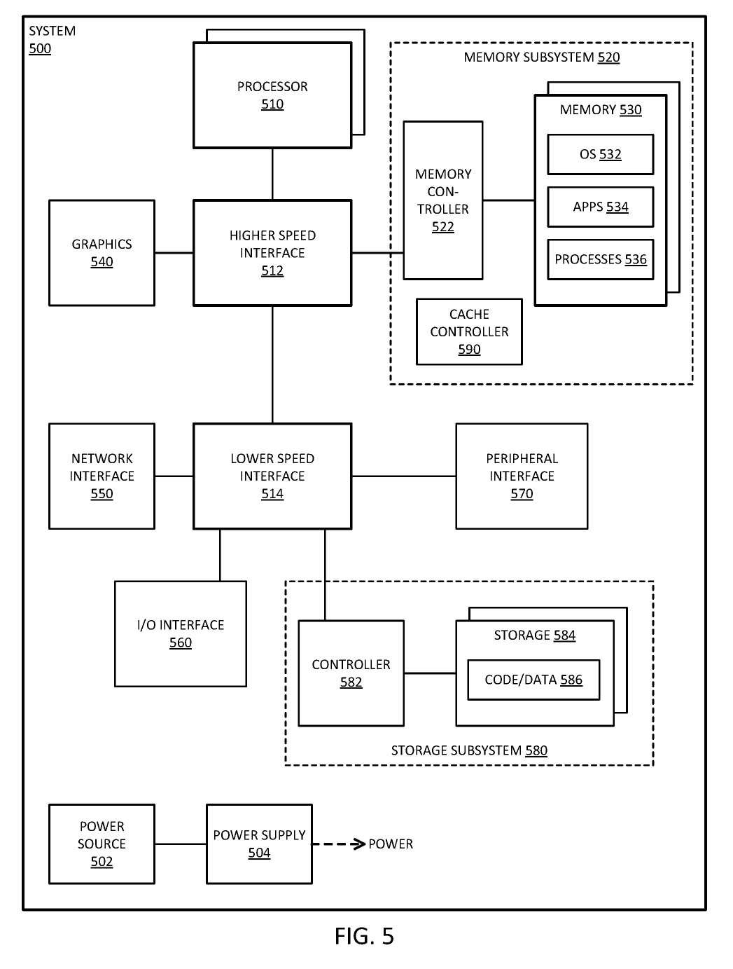

FIG. 5 is a block diagram of an embodiment of a computing system with a multilevel memory in which high compressibility flags can be implemented. System 500 represents a computing device in accordance with any embodiment described herein, and can be a laptop computer, a desktop computer, a tablet computer, a server, a gaming or entertainment control system, a scanner, copier, printer, routing or switching device, embedded computing device, a smartphone, a wearable device, an internet-of-things device or other electronic device.

System 500 includes processor 510, which provides processing, operation management, and execution of instructions for system 500. Processor 510 can include any type of microprocessor, central processing unit (CPU), graphics processing unit (GPU), processing core, or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one embodiment, system 500 includes interface 512 coupled to processor 510, which can represent a higher speed interface or a high throughput interface for system components that needs higher bandwidth connections, such as memory subsystem 520 or graphics interface components 540. Interface 512 can represent a “north bridge” circuit, which can be a standalone component or integrated onto a processor die. Where present, graphics interface 540 interfaces to graphics components for providing a visual display to a user of system 500. In one embodiment, graphics interface 540 generates a display based on data stored in memory 530 or based on operations executed by processor 510 or both.

Memory subsystem 520 represents the main memory of system 500, and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one embodiment, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (commonly referred to as “Firewire”).

In one embodiment, system 500 includes interface 514, which can be coupled to interface 512. Interface 514 can be a lower speed interface than interface 512. In one embodiment, interface 514 can be a “south bridge” circuit, which can include standalone components and integrated circuitry. In one embodiment, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can exchange data with a remote device, which can include sending data stored in memory or receiving data to be stored in memory.

In one embodiment, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one embodiment, system 500 includes storage subsystem 580 to store data in a nonvolatile manner. In one embodiment, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (i.e., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (i.e., the value or state of the data is indeterminate if power is interrupted to system 500). In one embodiment, storage subsystem 580 includes controller 582 to interface with storage 584. In one embodiment controller 582 is a physical part of interface 514 or processor 510, or can include circuits or logic in both processor 510 and interface 514.

Power source 502 provides power to the components of system 500. More specifically, power source 502 typically interfaces to one or multiple power supplies 504 in system 502 to provide power to the components of system 500. In one embodiment, power supply 504 includes an AC to DC (alternating current to direct current) adapter to plug into a wall outlet. Such AC power can be renewable energy (e.g., solar power) power source 502. In one embodiment, power source 502 includes a DC power source, such as an external AC to DC converter. In one embodiment, power source 502 or power supply 504 includes wireless charging hardware to charge via proximity to a charging field. In one embodiment, power source 502 can include an internal battery or fuel cell source.

System 500 illustrates cache controller 590 in memory subsystem 520, which represents a cache controller that includes and uses high compressibility flags in accordance with any embodiment described herein. Cache controller 590 can be understood to be part of a multilevel memory with a cache (not specifically shown) as well as memory 530. In one embodiment, cache controller 590 includes on resource HC flags that can be accessed with lower latency than a cache data store. In one embodiment, cache controller 590 is integrated on processor 510 or interface 512. In one embodiment, cache controller 590 is part of memory controller 522. Cache controller 590 returns fulfillment of memory access requests for cached data based on a value of a high compressibility flag in accordance with any embodiment described herein.

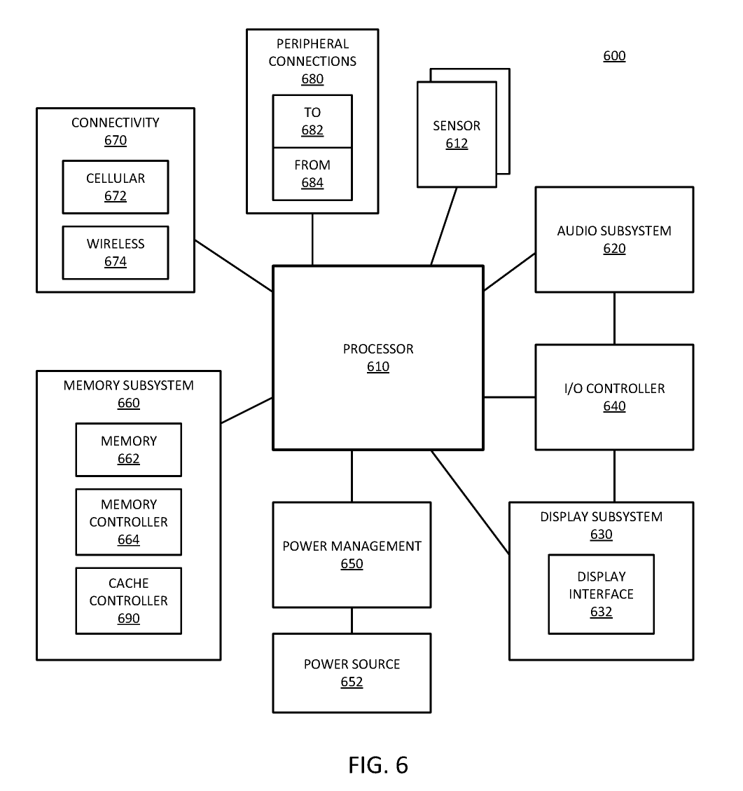

FIG. 6 is a block diagram of an embodiment of a mobile device with a multilevel memory in which high compressibility flags can be implemented. Device 600 represents a mobile computing device, such as a computing tablet, a mobile phone or smartphone, a wireless-enabled e-reader, wearable computing device, an internet-of-things device or other mobile device, or an embedded computing device. It will be understood that certain of the components are shown generally, and not all components of such a device are shown in device 600.

Device 600 includes processor 610, which performs the primary processing operations of device 600. Processor 610 can include one or more physical devices, such as microprocessors, application processors, microcontrollers, programmable logic devices, or other processing means. The processing operations performed by processor 610 include the execution of an operating platform or operating system on which applications and device functions are executed. The processing operations include operations related to I/O (input/output) with a human user or with other devices, operations related to power management, operations related to connecting device 600 to another device, or a combination. The processing operations can also include operations related to audio I/O, display I/O, or other interfacing, or a combination. Processor 610 can execute data stored in memory. Processor 610 can write or edit data stored in memory.

In one embodiment, system 600 includes one or more sensors 612. Sensors 612 represent embedded sensors or interfaces to external sensors, or a combination. Sensors 612 enable system 600 to monitor or detect one or more conditions of an environment or a device in which system 600 is implemented. Sensors 612 can include environmental sensors (such as temperature sensors, motion detectors, light detectors, cameras, chemical sensors (e.g., carbon monoxide, carbon dioxide, or other chemical sensors)), pressure sensors, accelerometers, gyroscopes, medical or physiology sensors (e.g., biosensors, heart rate monitors, or other sensors to detect physiological attributes), or other sensors, or a combination. Sensors 612 can also include sensors for biometric systems such as fingerprint recognition systems, face detection or recognition systems, or other systems that detect or recognize user features. Sensors 612 should be understood broadly, and not limiting on the many different types of sensors that could be implemented with system 600. In one embodiment, one or more sensors 612 couples to processor 610 via a frontend circuit integrated with processor 610. In one embodiment, one or more sensors 612 couples to processor 610 via another component of system 600.

In one embodiment, device 600 includes audio subsystem 620, which represents hardware (e.g., audio hardware and audio circuits) and software (e.g., drivers, codecs) components associated with providing audio functions to the computing device. Audio functions can include speaker or headphone output, as well as microphone input. Devices for such functions can be integrated into device 600, or connected to device 600. In one embodiment, a user interacts with device 600 by providing audio commands that are received and processed by processor 610.

Display subsystem 630 represents hardware (e.g., display devices) and software components (e.g., drivers) that provide a visual display for presentation to a user. In one embodiment, the display includes tactile components or touchscreen elements for a user to interact with the computing device. Display subsystem 630 includes display interface 632, which includes the particular screen or hardware device used to provide a display to a user. In one embodiment, display interface 632 includes logic separate from processor 610 (such as a graphics processor) to perform at least some processing related to the display. In one embodiment, display subsystem 630 includes a touchscreen device that provides both output and input to a user. In one embodiment, display subsystem 630 includes a high definition (HD) display that provides an output to a user. High definition can refer to a display having a pixel density of approximately 100 PPI (pixels per inch) or greater, and can include formats such as full HD (e.g., 1080p), retina displays, 4K (ultra high definition or UHD), or others. In one embodiment, display subsystem 630 generates display information based on data stored in memory and operations executed by processor 610.

I/O controller 640 represents hardware devices and software components related to interaction with a user. I/O controller 640 can operate to manage hardware that is part of audio subsystem 620, or display subsystem 630, or both. Additionally, I/O controller 640 illustrates a connection point for additional devices that connect to device 600 through which a user might interact with the system. For example, devices that can be attached to device 600 might include microphone devices, speaker or stereo systems, video systems or other display device, keyboard or keypad devices, or other I/O devices for use with specific applications such as card readers or other devices.

As mentioned above, I/O controller 640 can interact with audio subsystem 620 or display subsystem 630 or both. For example, input through a microphone or other audio device can provide input or commands for one or more applications or functions of device 600. Additionally, audio output can be provided instead of or in addition to display output. In another example, if display subsystem includes a touchscreen, the display device also acts as an input device, which can be at least partially managed by I/O controller 640. There can also be additional buttons or switches on device 600 to provide I/O functions managed by I/O controller 640.

In one embodiment, I/O controller 640 manages devices such as accelerometers, cameras, light sensors or other environmental sensors, gyroscopes, global positioning system (GPS), or other hardware that can be included in device 600, or sensors 612. The input can be part of direct user interaction, as well as providing environmental input to the system to influence its operations (such as filtering for noise, adjusting displays for brightness detection, applying a flash for a camera, or other features).

In one embodiment, device 600 includes power management 650 that manages battery power usage, charging of the battery, and features related to power saving operation. Power management 650 manages power from power source 652, which provides power to the components of system 600. In one embodiment, power source 652 includes an AC to DC (alternating current to direct current) adapter to plug into a wall outlet. Such AC power can be renewable energy (e.g., solar power, motion based power). In one embodiment, power source 652 includes only DC power, which can be provided by a DC power source, such as an external AC to DC converter. In one embodiment, power source 652 includes wireless charging hardware to charge via proximity to a charging field. In one embodiment, power source 652 can include an internal battery or fuel cell source.

Memory subsystem 660 includes memory device(s) 662 for storing information in device 600. Memory subsystem 660 can include nonvolatile (state does not change if power to the memory device is interrupted) or volatile (state is indeterminate if power to the memory device is interrupted) memory devices, or a combination. Memory 660 can store application data, user data, music, photos, documents, or other data, as well as system data (whether long-term or temporary) related to the execution of the applications and functions of system 600. In one embodiment, memory subsystem 660 includes memory controller 664 (which could also be considered part of the control of system 600, and could potentially be considered part of processor 610). Memory controller 664 includes a scheduler to generate and issue commands to memory device 662.

Connectivity 670 includes hardware devices (e.g., wireless or wired connectors and communication hardware, or a combination of wired and wireless hardware) and software components (e.g., drivers, protocol stacks) to enable device 600 to communicate with external devices. The external device could be separate devices, such as other computing devices, wireless access points or base stations, as well as peripherals such as headsets, printers, or other devices. In one embodiment, system 600 exchanges data with an external device for storage in memory or for display on a display device. The exchanged data can include data to be stored in memory, or data already stored in memory, to read, write, or edit data.

Connectivity 670 can include multiple different types of connectivity. To generalize, device 600 is illustrated with cellular connectivity 672 and wireless connectivity 674. Cellular connectivity 672 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), or other cellular service standards. Wireless connectivity 674 refers to wireless connectivity that is not cellular, and can include personal area networks (such as Bluetooth), local area networks (such as WiFi), or wide area networks (such as WiMax), or other wireless communication, or a combination. Wireless communication refers to transfer of data through the use of modulated electromagnetic radiation through a non-solid medium. Wired communication occurs through a solid communication medium.

Peripheral connections 680 include hardware interfaces and connectors, as well as software components (e.g., drivers, protocol stacks) to make peripheral connections. It will be understood that device 600 could both be a peripheral device (“to” 682) to other computing devices, as well as have peripheral devices (“from” 684) connected to it. Device 600 commonly has a “docking” connector to connect to other computing devices for purposes such as managing (e.g., downloading, uploading, changing, synchronizing) content on device 600. Additionally, a docking connector can allow device 600 to connect to certain peripherals that allow device 600 to control content output, for example, to audiovisual or other systems.

In addition to a proprietary docking connector or other proprietary connection hardware, device 600 can make peripheral connections 680 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other type.

System 600 illustrates cache controller 690 in memory subsystem 660, which represents a cache controller that includes and uses high compressibility flags in accordance with any embodiment described herein. Cache controller 690 can be understood to be part of a multilevel memory with a cache (not specifically shown) as well as memory 662. In one embodiment, cache controller 690 includes on resource HC flags that can be accessed with lower latency than a cache data store. In one embodiment, cache controller 690 is integrated on processor 610. In one embodiment, cache controller 690 is part of memory controller 664. Cache controller 690 returns fulfillment of memory access requests for cached data based on a value of a high compressibility flag in accordance with any embodiment described herein.

In one aspect, a system for data storage and access includes: a main memory device to store data at a memory location; an auxiliary memory device to store a copy of the data; and a cache controller to determine whether the memory location includes highly compressible data; store a flag proximate the cache controller as a representation for high compressibility, wherein the flag is to include a field accessible without external input/output (I/O) from the cache controller, and the field to indicate whether the data includes highly compressible data; and in response to a memory access request for the memory location, return fulfillment of the memory access request according to the representation of high compressibility indicated by the flag. In one aspect, a near memory cache includes: an auxiliary memory device to store a copy of data stored in a primary system memory; and a cache controller to determine whether the memory location includes highly compressible data; store a flag proximate the cache controller as a representation for high compressibility, wherein the flag is to include a field accessible without external input/output (I/O) from the cache controller, and the field to indicate whether the data includes highly compressible data; and in response to a memory access request for the memory location, return fulfillment of the memory access request according to the representation of high compressibility indicated by the flag.

In one embodiment, the highly compressible data comprises all zeros (AZ) data. In one embodiment, the cache controller is to identify the data as highly compressible data in connection with initial allocation of an entry in the auxiliary memory for the memory location. In one embodiment, the cache controller to store the flag comprises the cache controller to store the flag in a memory structure of the cache controller dedicated to storage of flags as representations of high compressibility. In one embodiment, cache controller to store the flag comprises the cache controller to store the flag as part of a memory structure to store metadata for cache entries. In one embodiment, the memory access request comprises a read request. In one embodiment, the memory access request comprises a write request. In one embodiment, the flag comprises a representation of high compressibility for only a portion of the memory location, and wherein the memory access request comprises a write request to the portion. In one embodiment, the field comprises a single bit. In one embodiment, the field comprises multiple bits, wherein different permutations of bit values represent different variations of highly compressible data. In one embodiment, the flag includes a bit field, wherein different bits of the bit field indicate separate portions of a page of data. In one embodiment, the flag to indicate high compressibility for an entire page of data. In one embodiment, the cache controller to return fulfillment of the memory access request comprises the cache controller to acknowledge a write request without marking a cache entry dirty for the memory location. In one embodiment, the cache controller is further to reallocate a cache entry to a different memory location while maintaining a value of the flag. In one embodiment, the cache controller comprises a cache controller integrated on a processor die. In one embodiment, the cache controller to return fulfillment of the memory access request according to the representation of the highly compressible data comprises the cache controller to return fulfillment of the memory access request based on the representation of high compressibility of the flag instead of access to the memory location. In one embodiment, further comprising one or more of: at least one processor communicatively coupled to the cache controller; a memory controller communicatively coupled to the cache controller; a display communicatively coupled to at least one processor; a battery to power the system; or a network interface communicatively coupled to at least one processor.

In one aspect, a method for data access includes: determining whether data at a memory location includes highly compressible data, wherein a main memory device is to store the data at the memory location, and wherein an auxiliary memory device is to store a copy of the data; storing a flag on-resource proximate a cache controller as a representation for high compressibility, wherein the flag including a field accessible without external input/output (I/O) by the cache controller, and the field to indicate whether the data includes highly compressible data; and in response to a memory access request for the memory location, returning fulfillment of the memory access request according to the representation of high compressibility indicated by the flag.

In one embodiment, the highly compressible data comprises all zeros (AZ) data. In one embodiment, storing the flag comprises storing the flag in connection with initial allocation of an entry in the auxiliary memory for the memory location. In one embodiment, storing the flag comprises storing the flag in a memory structure dedicated to storage of flags. In one embodiment, storing the flag comprises storing the flag in a memory structure for metadata for cache entries. In one embodiment, the memory access request comprises a read request. In one embodiment, the memory access request comprises a write request. In one embodiment, the flag comprises a representation of high compressibility for only a portion of the memory location, and wherein the memory access request comprises a write request to the portion. In one embodiment, the flag comprises a single bit. In one embodiment, the flag comprises a bit field wherein different permutations of bit values represent different variations of highly compressible data. In one embodiment, the flag comprises a bit field wherein different bits of the bit field indicate separate portions of a page of data. In one embodiment, the flag indicates high compressibility for an entire page of data. In one embodiment, returning fulfillment of the memory access request comprises acknowledging the write request without marking a cache entry dirty for the memory location. In one embodiment, further comprising: reallocating a cache entry to a different memory location while maintaining a value of the flag. In one embodiment, returning fulfillment of the memory access request according to the representation of the highly compressible data comprises: returning fulfillment of the memory access request based on the representation of high compressibility of the flag instead of access to the memory location.

In one aspect, an apparatus includes means for performing operations to execute a method for data access in accordance with any embodiment of a method as set out above. In one aspect, an article of manufacture comprising a computer readable storage medium having content stored thereon, which when accessed causes a device to perform operations to execute a method in accordance with any embodiment of a method as set out above.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware, software, or a combination. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, data, or a combination. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters or sending signals, or both, to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A system, comprising:
a main memory device to store data at a memory location;
an auxiliary memory device to store a copy of the data; and
a cache controller to
determine whether the memory location includes highly compressible data; store a flag proximate the cache controller as a representation for high compressibility, wherein the flag is to include a field accessible without external input/output (I/O) from the cache controller, and the field to indicate whether the data includes highly compressible data; and in response to a memory access request for the memory location, return fulfillment of the memory access request according to the representation of high compressibility indicated by the flag.

2. The system of claim 1, wherein the highly compressible data comprises all zeros (AZ) data.

3. The system of claim 1, wherein the cache controller is to identify the data as highly compressible data in connection with initial allocation of an entry in the auxiliary memory for the memory location.

4. The system of claim 1, wherein the cache controller to store the flag comprises the cache controller to store the flag in a memory structure of the cache controller dedicated to storage of flags as representations of high compressibility.

5. The system of claim 1, wherein the cache controller to store the flag comprises the cache controller to store the flag as part of a memory structure to store metadata for cache entries.

6. The system of claim 1, wherein the memory access request comprises a read request.

7. The system of claim 1, wherein the memory access request comprises a write request.

8. The system of claim 7, wherein the flag comprises a representation of high compressibility for only a portion of the memory location, and wherein the memory access request comprises a write request to the portion.

9. The system of claim 1, wherein the field comprises a single bit.

10. The system of claim 1, wherein the field comprises multiple bits, wherein different permutations of bit values represent different variations of highly compressible data.

11. The system of claim 1, wherein the flag includes a bit field, wherein different bits of the bit field indicate separate portions of a page of data.

12. The system of claim 1, wherein the flag to indicate high compressibility for an entire page of data.

13. The system of claim 1, wherein the cache controller to return fulfillment of the memory access request comprises the cache controller to acknowledge a write request without marking a cache entry dirty for the memory location.

14. The system of claim 1, wherein the cache controller is further to
reallocate a cache entry to a different memory location while maintaining a value of the flag.

15. The system of claim 1, wherein the cache controller comprises a cache controller integrated on a processor die.

16. The system of claim 1, wherein the cache controller to return fulfillment of the memory access request according to the representation of the highly compressible data comprises the cache controller to
return fulfillment of the memory access request based on the representation of high compressibility of the flag instead of access to the memory location.

17. The system of claim 1, further comprising one or more of:
at least one processor communicatively coupled to the cache controller;
a memory controller communicatively coupled to the cache controller;
a display communicatively coupled to at least one processor;
a battery to power the system; or
a network interface communicatively coupled to at least one processor.

18. A method for data access, comprising:
determining whether data at a memory location includes highly compressible data, wherein a main memory device is to store the data at the memory location, and wherein an auxiliary memory device is to store a copy of the data;
storing a flag on-resource proximate a cache controller as a representation for high compressibility, wherein the flag including a field accessible without external input/output (I/O) by the cache controller, and the field to indicate whether the data includes highly compressible data; and
in response to a memory access request for the memory location, returning fulfillment of the memory access request according to the representation of high compressibility indicated by the flag.

19. The method of claim 18, wherein the highly compressible data comprises all zeros (AZ) data.

20. The method of claim 18, wherein storing the flag comprises storing the flag in a memory structure dedicated to storage of flags, or a memory structure for metadata for cache entries.

21. The method of claim 18, wherein the memory access request comprises a write request, and wherein the flag comprises a representation of high compressibility for only a portion of the memory location, and wherein the memory access request comprises a write request to the portion.

22. The method of claim 18, wherein the flag comprises a single bit, or a bit field wherein different permutations of bit values represent different variations of highly compressible data, or a bit field wherein different bits of the bit field indicate separate portions of a page of data.

23. The method of claim 18, wherein the flag indicates high compressibility for an entire page of data.

24. The method of claim 18, wherein returning fulfillment of the memory access request comprises acknowledging the write request without marking a cache entry dirty for the memory location.

25. The method of claim 18, further comprising:
reallocating a cache entry to a different memory location while maintaining a value of the flag.

26. The method of claim 18, wherein returning fulfillment of the memory access request according to the representation of the highly compressible data comprises:
returning fulfillment of the memory access request based on the representation of high compressibility of the flag instead of access to the memory location.
